(19) United States
(12) Patent Application Publication
(10) Pub. No.: US 2023/0026903 A1
(43) Pub. Date: Jan. 26, 2023

(54) SYSTEM AND METHOD FOR PROPAGATING SEEDS TO SEEDLINGS WITHIN AN AGRICULTURAL FACILITY

(71) Applicant: Iron Ox, Inc., San Carlos, CA (US)

(72) Inventors: Thomas Kendall, San Jose, CA (US); Saqib Naveed, Santa Clara, CA (US); Winnie Ding, Redwood City, CA (US); Peter Turner, San Carlos, CA (US); Lola Siboldi, Gilroy, CA (US)

(73) Assignee: Iron Ox, Inc., San Carlos, CA (US)

(21) Appl. No.: 17/865,360

(22) Filed: Jul. 14, 2022

Related U.S. Application Data
(60) Provisional application No. 63/225,359, filed on Jul. 23, 2021.

(51) Int. Cl. A01G 31/06

(52) U.S. Cl. CPC A01G 31/06; A01G 2031/006

(57) ABSTRACT

A propagation system for growing seeds to seedlings, the propagation system comprising: a holding tank configured to be coupled to a water supply; a first plurality of rack docks and a second plurality of rack docks; a central wall disposed between and separating the first plurality of rack docks from the second plurality of rack docks, the central wall comprising water supply infrastructure configured to deliver nutriated water from the holding tank to the first and second plurality of rack docks and water return infrastructure configured to return nutriated water from the first and second plurality of rack docks to the holding tank; one or more pumps operatively coupled to pump nutriated water through the water supply infrastructure and through the water return infrastructure; wherein each rack dock in the first plurality of rack docks and each rack dock in the second plurality of rack docks defines a set of propagation tray locations, each propagation tray location in each set of propagation tray locations including at least one water supply line coupled to the water supply infrastructure and at least one water drain line coupled to the water return infrastructure.

### CROSS-REFERENCES TO RELATED APPLICATIONS

This application claims priority to U.S. Provisional Application No. 63/225,359, filed on Jul. 23, 2021, the disclosure of which is hereby incorporated by reference in its entirety for all purposes.

### TECHNICAL FIELD

This invention relates generally to the field of agricultural systems and more specifically to a new and useful system and method for propagating seeds to seedlings within an agricultural facility in the field of agricultural systems.

### BACKGROUND OF THE INVENTION

Global Warming is the long-term warming of the planet's overall temperature. While this warming trend has been going on for a long time, scientists believe almost uniformly that its pace has increased in the last hundred years due to the burning of fossil fuels and other human-induced activities that generate gases which contribute to what scientists refer to as the “greenhouse effect”. Greenhouse gases form a layer in the upper atmosphere of the planet that is more transparent to visible radiation from the sun than to infrared radiation emitted from the planet's surface. Thus, as the sun's radiation warms the surface of the earth, the earth's atmosphere prevents some of the heat from returning directly to space resulting in a warmer planet.

Climate change, which has resulted in changes in weather patterns and growing seasons around the world, is a direct result of global warming. The warming weather can generate extreme weather conditions, such as drought and fires in some areas, more frequent and stronger hurricanes in other areas, tornadoes, flooding and other extreme weather related events across the globe. The changing weather patterns can also result in adverse changes to our ecosystem. For example, milder winters can allow insects to survive in greater numbers in some areas and/or to emerge earlier in the spring putting additional pressure on trees and plants that can lead to die-off in some instances. As another example, warmer air and ocean temperatures can cause coral bleaching where corals lose their color and die potentially wiping out whole ecosystems that depend on the reefs for food and shelter. Thus, it is imperative that humans reduce, or even reverse, their impact on global warming by reducing their carbon footprint.

Traditional farming techniques have a large impact on our overall carbon footprint. According to some studies, agriculture is the second-leading source of carbon dioxide (CO₂) emissions. For example, traditional farming relies on nitrogen fertilizers produced from manufacturing processes that generate a significant source of greenhouse gases. Crops typically use up only a portion of the nitrogen from fertilizers with the remainder getting broken down by microbes in the soil or getting run off into waterways. Additionally, most vegetable and fruit crops grown by traditional agriculture methods are far away from the ultimate location where they will be consumed. Not only does this require that the crops be trucked long distances, thus burning a lot of gas in the process, it can also require harvesting crops before they are actually ripe based on an estimated time to delivery lest crops be overly ripe and spoiled upon arrival. These and other factors combine to result in an undesirably high percentage of vegetables and fruit being not suitable for sale and being thrown out.

Various efforts have been made to improve upon traditional farming techniques. For example, some companies are growing fruits and vegetables locally, close to or within major population centers, using hydroponics and indoor vertical farming techniques. While these solutions may solve the transportation problem and reduce the amount of fertilizer required, indoor vertical farming is dependent on LED or similar lighting. Energy costs to generate the lighting required for such farming can be very high, challenging profitability. Also, using fossil-fuel powered electricity undermines the potential environmental benefits of indoor vertical farming. Thus, vertical indoor farming is not an ideal solution to the environmental challenges presented by traditional farming.

Accordingly, new and improved methods and techniques for growing high-quality fruits, vegetables and other food in a sustainable, low cost manner are desirable.

### BRIEF SUMMARY OF THE INVENTION

Embodiments described herein pertain to a system and method for propagating seeds to seedlings within an agricultural facility. Some embodiments pertain to an integrated system that provides automated lighting and flooding of plants throughout the propagation process. Nutrient-rich water can be delivered by the system under flexible software control over water flow, nutrient content and scheduling. The system can include various sensors and a controller that can monitor the conditions under which seeds are propagated to seedlings in the system and self-adjust the conditions, when necessary or appropriate, in accordance with propagation schedules that can be set by an operator or by the system based on the type of plant(s) grown at different locations within the system.

While the embodiments described herein can be useful for propagating seeds to seedlings in many different types of facilities, some embodiments are particularly useful when included in an agricultural facility that has been designed from the ground up with the intention of reducing the carbon footprint associated with growing plants within the facility. In some implementations, such a facility can include a first area for initially propagating plants from a seed to a seedling stage that is physically separated from a second area in which the plants can be housed within a greenhouse portion of the facility and grown with natural lighting during the remainder of their growth cycle until being harvested. In such a facility, plants can be propagated by the system within the first area within a first container type at a first, relatively high density (i.e., individual plants can be very closely spaced next to neighboring plants). Then, once the plants have reached an appropriate, intermediate stage of growth, the plants can transferred to from the first container type to a second container type at a second, lower density (i.e., individual plants are spaced further apart from each other to allow for growth to maturity). The second container type can then be transported to the second area within the agricultural facility where the plants can reside until being harvested.

According to some embodiments, a propagation system for growing seeds to seedlings is disclosed where the propagation system comprises: a holding tank configured to be coupled to a water supply; a first plurality of rack docks and a second plurality of rack docks; a central wall disposed between and separating the first plurality of rack docks from the second plurality of rack docks, the central wall comprising water supply infrastructure configured to deliver nutriated water from the holding tank to the first and second plurality of rack docks and water return infrastructure configured to return nutriated water from the first and second plurality of rack docks to the holding tank; one or more pumps operatively coupled to pump nutriated water through the water supply infrastructure and through the water return infrastructure; wherein each rack dock in the first plurality of rack docks and each rack dock in the second plurality of rack docks defines a set of propagation tray locations, each propagation tray location in each set of propagation tray locations including at least one water supply line coupled to the water supply infrastructure and at least one water drain line coupled to the water return infrastructure.

In various implementations, the propagation system can include one or more of the following features. The propagation system can include an acid dosing subsystem operatively coupled to add acid to water in the holding tank. The holding tank can be configured to be coupled to a fresh water supply and the propagation system can include one or more nutrient tanks operatively coupled to deliver nutrients to the holding tank, and one or more nutrient pumps operatively coupled to meter nutrients from the one or more nutrient tanks into the holding tank. The propagation system can include one or more sensors disposed within the holding tank to measure the pH and nutrient levels of water in the holding tank. Each rack dock can include a drain assembly positioned at each propagation tray location of the rack dock. The drain assembly can include a bowl and a drain coupled to the water return infrastructure and configured to transport water received at the bowl to the water return infrastructure. The propagation system can include a plurality of racks and a plurality of propagation trays. Each rack can define a set of levels and each propagation tray can be sized and shaped to fit within one of the levels on a rack. The propagation system can include a plurality of propagation trays, and each propagation tray can include a basin configured to hold a plurality of plants in a bath of water and a drain port located in a sump region of the propagation tray. Each propagation tray can include a fill port separated from a portion of the basin by a barrier wall that extends between first and second opposing sides of the propagation tray. Each propagation tray can include a stopper pivotably coupled to a bottom surface of the propagation tray. The stopper can include a sealing plate that can be rotated, at an axis defined by a hinge, between a closed position in which the sealing plate covers and seals the drain port and an open position in which the sealing plate is rotated away from the drain port. The stopper can include a biasing mechanism that biases the sealing plate into the closed position and a gasket coupled to the sealing plate, wherein the gasket is positioned to contact and cover the drain port when the stopper is in the closed position. Each rack in the plurality of racks can include an armature plate and each rack dock in the first and second pluralities of rack docks can include an electromagnet aligned to mate with the armature plate of a rack in the plurality of racks to pull the rack into and secure the rack within the rack dock. The propagation system can be a stand-alone system that can be moved to different locations within an agricultural facility without taking the system apart.

In various implementations, the propagation system can also include one or more of the following features. The propagation system can include a controller configured to self-monitor growing conditions at a rack dock, in accordance with a propagation schedule assigned to the rack dock, by initiating a plurality of flood cycles to irrigate plants growing in propagation trays within the rack dock with nutriated water as the plants grow from a seed to seedling stage and adjusting nutrients in the nutriated water directed to the propagation trays in each flood cycle based on data received from the plurality of sensors. Each propagation tray location in each set of propagation tray locations can include: (i) at least one water supply valve operatively coupled to control a flow of nutriated water from the water supply infrastructure into the water supply line at the propagation tray location, and (ii) at least one water drain valve operatively coupled to control a flow of nutriated water from the propagation tray location into the water return infrastructure. The propagation system can include a controller coupled to a computer-readable memory that stores a propagation schedule. The controller can be operatively coupled to open and close each water supply valve and to open and close each water drain valve in accordance with the propagation schedule stored in the computer-readable memory. The controller can be operatively coupled to: (i) open and close each water supply valve at each propagation tray location independent from the water supply valves at every other propagation tray location, and (ii) open and close each water drain valve at each propagation tray location independent from the water drain valves at every other propagation tray location.

According to some embodiments, a method for growing a first plurality of plants from seeds to a seedling stage in a first propagator station tray positioned within a first docking area of propagator station and a second plurality of plants in a second propagation tray positioned within a second docking area of the propagator station is disclosed where the propagator station includes a holding tank, and one or more water quality sensors. The method can include: preparing an initial batch of nutriated water in the holding tank; irrigating the first plurality of plants with the nutriated water by flowing the nutriated water into the first propagation tray in accordance with a first propagation schedule; draining nutriated water from the first propagation tray and returning the drained water to the holding tank; measuring one or more characteristics of the drained water with the one or more water quality sensors to determine if the water quality meets predetermined criteria established for the second propagation schedule; if the water quality meets the predetermined criteria, irrigating the second plurality of plants with the drained water in accordance with the second propagation schedule; and if the water quality does not meet the predetermined criteria, preparing adjusted nutrient water by adding one or more nutrients from the one or more nutrient tanks to the drained water and irrigating the second plurality of plants with the adjusted nutriated water by flowing the adjusted nutriated water into the second propagation tray according in accordance with the second propagation schedule.

In some implementations, the method can include one or more of the following. The propagator station can further comprise one or more nutrient tanks and the step of preparing an initial batch of nutriated water in the holding tank can include combining fresh water with nutrients from the one or more nutrient tanks. The propagator station can further include an acid dosing subsystem, and the step of measuring one or more characteristics of the drained water can include measuring a pH level of the drained water. The method can further include, if the pH level of the drained water is above a predetermined range established for the second propagation schedule, preparing adjusted nutrient water by adding acid to the drained water and irrigating the second plurality of plants with the adjusted nutriated water by flowing the adjusted nutriated water into the second propagation tray according in accordance with the second propagation schedule. The propagator station can include a plurality of rack docks, the first propagation tray can be one of a plurality of first propagation trays stacked vertically within a first rack dock and the second propagation tray can be one of a plurality of second propagation trays stacked vertically within a second rack dock.

In some implementations, the method can also include: irrigating the first plurality of plants with the nutriated water flows the nutriated water into each of the first propagation trays in the plurality of first propagation trays in accordance with the first propagation schedule; draining the nutriated water from the first propagation tray and returning the drained water to the holding tank drains the water from each of the first propagation trays in the plurality of first propagation trays; irrigating the second plurality of plants with the drained water flows the drained water into each of the second propagation trays in the plurality of second propagation trays in accordance with the second propagation schedule; and irrigating the second plurality of plants with the adjusted nutriated water flows the adjusted nutriated water into each of the second propagation tray in the plurality of second propagation trays in accordance with the second propagation schedule.

To better understand the nature and advantages of the present invention, reference should be made to the following description and the accompanying figures. It is to be understood, however, that each of the figures is provided for the purpose of illustration only and is not intended as a definition of the limits of the scope of the present invention. Also, as a general rule, and unless it is evident to the contrary from the description, where elements in different figures use the same reference numbers, the elements are generally either identical or at least similar in function or purpose.

### BRIEF DESCRIPTION OF THE DRAWINGS

FIG. 1 is a schematic representation of the layout of an example of an agricultural facility in which some embodiments disclosed herein can be used;

FIG. 2 is a schematic representation of some embodiments of a seed propagation system according to some embodiments disclosed herein;

FIG. 3 is simplified perspective view illustration of a seed propagation system according to some embodiments disclosed herein;

FIG. 4 is simplified perspective view illustration of a seed propagation system according to some embodiments disclosed herein;

FIG. 5 is simplified side perspective view of a portion of a seed propagation system according to some embodiments;

FIG. 6 is a simplified perspective view of a wall section that can be incorporated into a seed propagation system according to some embodiments;

FIGS. 7A and 7B are simplified front and rear perspective views, respectively, of a portion of the wall section shown in FIG. 6;

FIGS. 8A and 8B are simplified front and rear perspective views, respectively, of a drain assembly that can incorporated into the wall section shown in FIG. 6;

FIG. 9A is a simplified perspective view of a rack with a set of propagation trays according to some embodiments that can be used in conjunction with seed propagation systems disclosed herein;

FIG. 9B is a simplified top plan view of a propagation cartridge according to some embodiments;

FIG. 10 is a simplified perspective view of a propagation tray according to some embodiments disclosed herein;

FIG. 11 is simplified perspective view illustration of a portion of a seed propagation tray according to some embodiments disclosed herein positioned within a seed propagation system according to some embodiments;

FIGS. 12A and 12B are simplified top and bottom perspective views of a drain assembly that can be incorporated into a propagation tray according to some embodiments;

FIGS. 13A to 13D are simplified illustrations depicting the operation of a drain plug assembly in accordance with some embodiments;

FIG. 14 is a simplified perspective view of a drain plug assembly that can be incorporated into a seed propagation system according to some embodiments;

FIG. 15 is a simplified bottom plan view of a shelf within a rack dock of a seed propagation system according to some embodiments;

FIG. 16 is a flowchart depicting steps associated of nutriating seeds or seedlings in a propagation tray according to some embodiments; and

FIGS. 17A to 17E are simplified illustrations depicting the operation of a drain plug assembly in accordance with some embodiments.

### DETAILED DESCRIPTION OF THE INVENTION

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

Embodiments described herein pertain to a system and method for propagating seeds to seedlings within an agricultural facility. Some embodiments pertain to an integrated system that provides automated lighting and flooding of plants throughout the propagation process. Nutrient-rich water can be delivered by the system under flexible software control over water flow, nutrient content and scheduling.

### Example Agricultural Facility

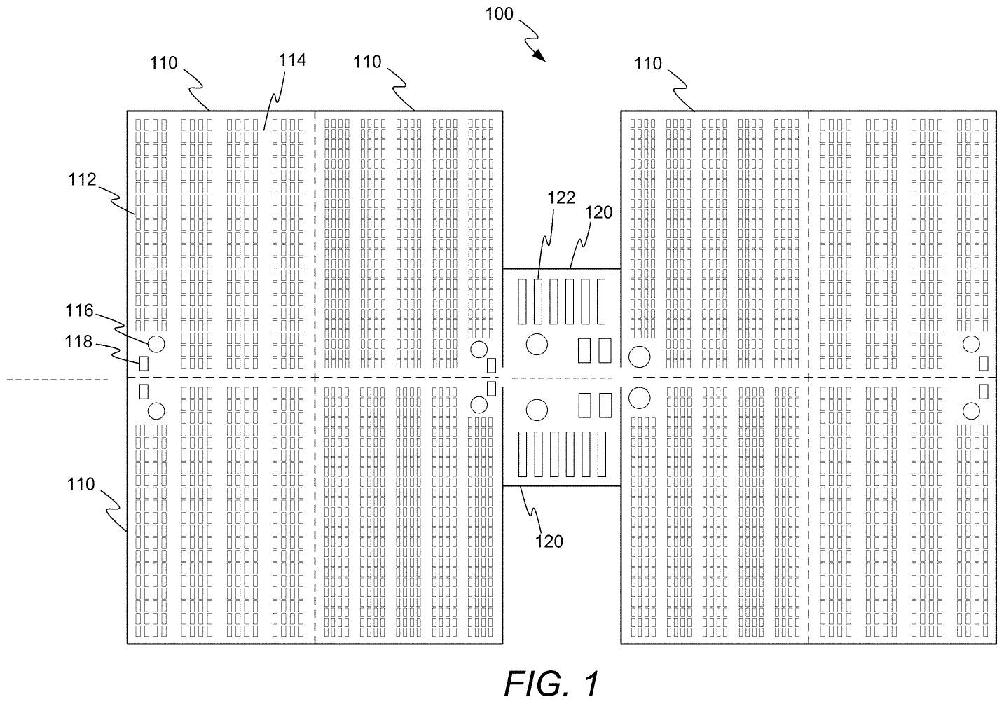

While the embodiments described herein can be useful for propagating seeds to seedlings in many different types of facilities or farms, some embodiments are particularly useful when included in an agricultural facility that has a first area for initially propagating plants from a seed to a seedling stage that is physically spaced apart from and/or separated from a second area in which the plants can be housed during the remainder of their growth cycle until being harvested. FIG. 1 is a schematic representation of the layout of an example of an agricultural facility 100 in which some embodiments disclosed herein can be used. Agricultural facility 100 has been designed to minimize the carbon footprint associated with growing and harvesting plants within the facility and is particularly well suited to being located close to major population centers to reduce the amount of gasoline that is burned when crops need to be trucked long distances as well as reduce the potential waste associated with traditional agricultural processes. It is to be understood that agricultural facility 100 is set forth herein for illustrative purposes only and that embodiments of the inventions disclosed herein can be used in agricultural facility 100 as well as many other types of agricultural facilities.

As depicted in FIG. 1, agricultural facility 100, which can include one or more greenhouses in which different portions of the agricultural facility reside, includes one or more farming blocks 110 along with one or more processing bays 120. The farming blocks 110 and processing bays 120 can be connected to each other, for example by hallways and/or common doors, so that plants, equipment, materials, personnel and other items can move between the farming blocks and processing bays without exiting the agricultural facility. To enable a certain amount of automation in the growth and harvesting of plants within facility 100, in some embodiments, movers (e.g, autonomous movers, not shown) can be provided that can be programmed or otherwise configured to autonomously move plants within agricultural facility 100 including moving plants within the various farming blocks 110, within the processing bays 120 and/or between the farming blocks 110 and the processing bays 120 without exiting the facility. Each mover can be an autonomous robot, such as described in U.S. Pat. No. 10,813,295 entitled “System and Method for Automating Transfer of Plants within an Agricultural Facility”, which is incorporated by reference herein in its entirety.

Generally, each processing bay 120 includes multiple stations (represented by various geometric shapes in FIG. 1 within the regions 120) in which various phases of the agricultural cycle occur. For example, within a given processing bay 120 can be separate stations that seed, germinate, pot, harvest, and/or package plants. In some embodiments, each processing bay 120 can function as an autonomous assembly line in which the multiple stations are automated and connected by conveyors and/or an autonomous mover. The multiple automated stations can cooperate to seed, germinate, pot, harvest, and package plants with minimal, or without any, need for a human laborer to handle the plants during those processes. Hence processing bays 120 are sometimes referred to herein as “automation bays 120”.

Plants can be automatically transported to the farming block (e.g., by an autonomous mover) after being initially propagated from a seed to a seedling in one of the automation bays 120 (e.g., in a propagation system 122). The farming blocks 110 can then function as longer term holding bays for plants between the potting and harvest stages. Each farming block 110 can be configured as an enclosed, environmentally-controlled grow area in which plants, after being transferred from the processing bay at an intermediate stage of growth, are provided with nutrients and light that they require to mature until the harvesting stage. Thus, a given plant can spend the majority of the agricultural cycle (i.e., the time between the potting and harvesting stages for the plant) in one of the farming blocks 110. In some embodiments, the farming blocks 110 can include controls and equipment to autonomously control growth input parameters (e.g., light, temperature, nutrients, etc.) to grow the plants under conditions that have been determined to be ideal for the particular plants.

The plants can be can be grown within farming blocks 110 in modules 112 that are distributed across the farming block and separated by aisles 114 accessible by the autonomous mover. In some embodiments, the modules 112 are distributed throughout the farming block in a horizontal arrangement (i.e., without plants being stacked vertically on top of other plants) so that the plants in each module have full access to natural light that enters the farming block through greenhouse windows around the sides and roof of the farming block. In some implementations, farming blocks 110 can grow plants using hydroponic techniques and each module 112 can include multiple rafts that float or partially float on a bed of nutrient-rich water within the module.

Each farming block 110 can also include, among other stations and/or equipment, a mobile imaging station 116 and a nutrient station 118. The mobile imaging station 116 can be configured to scan whole modules or individual rafts or trays within a module in the farming block, while the nutrient station can be configured to add water and nutrients to modules in the farming block. For example, a mover dedicated to the farming block can intermittently: deliver modules in the farming block to the module imaging station, which scans plants in the module and characterizes qualities of these plants and pest pressures in the module based on features detected in these images; and deliver modules in the farming block to the nutrient station, which refills the module with water and adjusts nutrient levels in the module.

While agricultural facility 100 is depicted in FIG. 1 as including eight separate farming blocks 110 and two automation bays 120, it is to be understood that this is for illustrative purposes only. In other embodiments facility 100 can include fewer or more than eight farming blocks 110 and can include fewer or more than two automation bays 120. Additionally, while agricultural facility is depicted with a farming block to automation bay ratio of 4:1, this ratio is also to be understood as serving illustrative purposes only and other embodiments can includes ratios lower than or higher than 4:1.

Agricultural facility 100 can be designed in a manner where the approach to growing fruits, vegetables and other plants has been completely rethought as compared to traditional farming techniques. For example, farming blocks 110 can represent the majority of the physical space of agricultural facility 100. Plants can spend the majority of their growth cycle in the farming blocks where they are grown with hydroponics techniques while being arranged throughout the farming blocks horizontally. Hydroponic growth methods can produce higher quality crops with better yields using less labor than traditional soil-based farming while also providing a large savings in terms of water and fertilizer as compared to traditional, soil-based farming techniques. The horizontal distribution of plants within the farming blocks 110 differs from the vertical arrangement of plants that is used in some indoor hydroponics farming facilities that then require large banks of artificial lights to adequately provide artificial sunlight for the plants. Such a horizontal arrangement can thus provide a large energy savings as compared to indoor vertical hydroponics farming techniques.

Also, instead of having a set of greenhouses defining primary operating areas within a facility, the combination of farming blocks 110 and processing bays 120 allow the processing bays 120 to function as the primary operating area of agricultural facility 100 with farming blocks 110 acting as automated greenhouses and functioning as infeed, outfeed, and holding zones for product flowing through the automation bays. For example, in some embodiments the agricultural facility can include one processing bay 120 and a set of farming blocks 110 arranged radially about the processing bay, each connected to the processing bay by a path traversable by the autonomous mover to transfer plants between the processing bay and the farming block.

Various sensors can be positioned throughout agricultural facility 100 to monitor all phases of, and all aspects of, plant growth within both farming blocks 110 and processing bays 120. Non-limiting examples of such sensors include: water quality sensors (e.g., sensors that monitor water temperature, water level, dissolved oxygen, pH, and/or nutrient levels), air quality sensors (e.g., sensors that monitor ambient air temperature, air speed, light level, relative humidity, carbon dioxide levels, oxygen levels, and the like) and pest sensors, among others. Data from the sensors can be collected, analyzed and used, in conjunction with the automated features of the agricultural facility, to ensure that each individual plant receives the optimal levels of sunshine, water, and nutrients. This level of precision towards the inputs used in the growth cycle, which is not readily obtainable with traditional agricultural techniques, can lead to using less water and less energy and emitting less CO₂ than traditional farming techniques while also generating less waste at every stage of the growth process.

Additionally, the data that can be continually collected from the plants grown within the facility can be used to constantly refine the growth and harvesting processes and improve both plant quality and quantity thereby reducing environmental impacts. For example, tracking precise levels of nutrients, water levels, temperature, and humidity, can lead to the creation of data models that can enable improved crop yield estimates and/or techniques to increase growth rates. The improved estimates can enable more precise harvesting of the crop so that agricultural facility 100 can respond to customer orders in a more accurate manner leading to less waste when what is shipped is essentially the same as what was ordered.

The collected data can also be used to adjust plant growing conditions in a manner that results in improvements in the growth rate and/or yield of each plant. Such efficiency gains can then allow greenhouses to produce more produce in a given space. The increased growth rates means a faster time to harvest, which can also increase the overall efficiency of agricultural facility 100.

Within the farming blocks 110 of agricultural facility 100, plants can be spaced apart from each other at a first spacing density that allows room for the plants to grow to their desired size prior to harvesting. The plants in the farming block can begin their growth cycle, however, in one of the processing bays 120. Since the plants are much smaller at their early growth stage, prior to be transferred to a framing block, in some implementations the plants can be propagated within a propagation system 122 that works with plants at a second spacing density where the plants are much more closely spaced together prior to being transplanted into the modules and transported to the farming blocks. That is, the second spacing density can be much denser than the first spacing density. For example, in some embodiments, plants can be propagated from a seed to seedling stage within plugs that are physically touching each other in the propagation system 122 or spaced less than a couple of millimeters (or less than 1 mm) apart from each other. After the plants reach the seedling stage, they can then be transferred to a potting system (e.g., a raft or a tray) where they are spaced apart several inches or more depending on the type of plant (e.g., basil plants can be transplanted into a potting system that might have a first spacing (in terms of inches) between adjacent basil plants while certain types of lettuces might grow better in a potting system that has a second spacing between plants that is greater than the first spacing.

Additionally, when plants are growing from the seed to seedling stage, the plants are generally not very tall. The plants' relatively low height, allows propagation system to stack the plants vertically within the system and grow the plants from seeds to seedlings with a combination of both natural light (e.g., light from greenhouse windows), supplemented with additional lighting, such as LED lighting, generated within propagation system 122. Since the plants can be grown to the seedlings stage within propagation system 122 at a very high density, the overall energy footprint required to grow plants at this seedling stage is significantly less than what would be required to grow the plants from seedlings to the harvesting stage.

Certain embodiments disclosed herein pertain to new and improved propagation systems, such as propagation system 122, that can propagate seeds and grow them to an intermediate, seedling stage as disclosed herein and discussed in more detail below.

### Example Propagation System

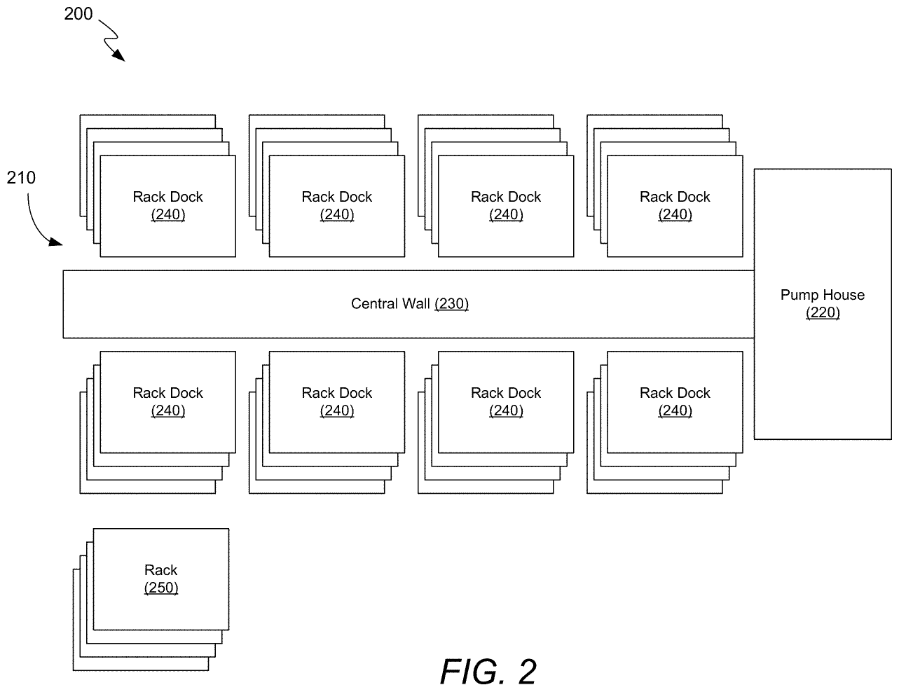

FIG. 2 is a simplified schematic view of a system 200 for propagating seeds to seedlings according to some embodiments. System 200, sometimes referred to herein as “propagation system 200” is representative of propagation system 122 discussed with respect to FIG. 1 and, in some implementations, can be a stand-alone system that resides within an agricultural facility, such as within one of the processing bays 120 of agricultural facility 100.

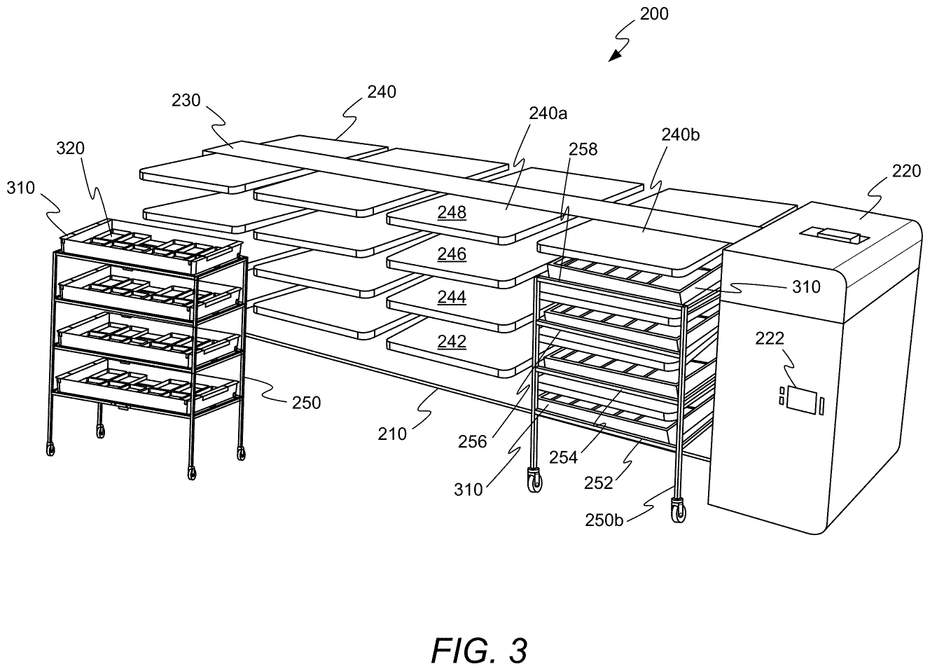

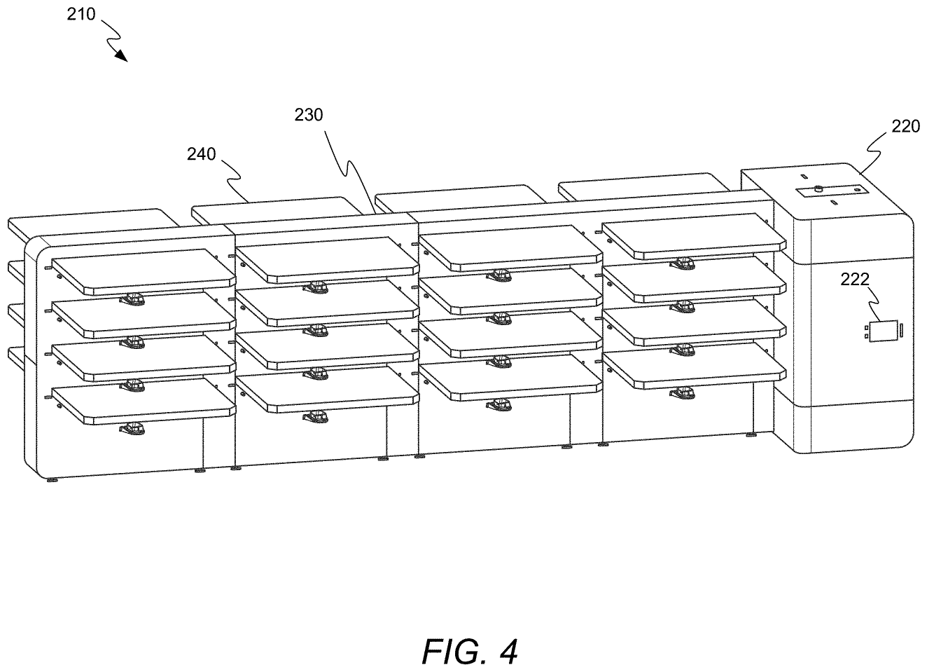

Propagation system 200, of which various views are also shown in FIGS. 3, 4 and 5, can be equipped with components and features that enable the system to self-monitor plants as they grow from a seed to a seedling with minimal or no interaction from a human operator. For example, in some implementations propagation system 200 can be an integrated system that autonomously receives various trays of seeds, provides automated lighting and flooding of the trays as the seeds grow to a seedling stage (e.g., in accordance with propagation schedules), and delivers nutrient-rich water to the growing plants under flexible software control of water flow, nutrient content and scheduling.

As shown in FIGS. 2-5, propagation system 200 can include a propagator station 210, a set of racks 250 (for ease of illustration, only one rack 250 is shown in FIG. 2), a set of propagation trays (FIG. 3, 310) and a set of propagation cartridges (FIG. 3, 320). Propagator station 210 can include a pump house 220, a center wall 230 and a set of rack docks 240 arranged along each side of the center wall 230. While not shown in the depicted embodiments, propagator station 210 can also include dividers (e.g., white or reflective panels) between adjacent rack docks. The dividers can help slow or prevent lateral spread of pests between racks occupying these rack docks, and/or can prevent light bleed between rack docks occupied by racks containing plants of different ages or types and therefore assigned different lighting types or intensities by propagation schedules associated with individual racks. As used herein, a “propagation schedule” is a program or schedule that can be implemented within propagation system 200 to grow seeds to seedlings in one or more of the rack docks. The program or schedule can include settings to any or all variables and conditions associated with the growth of the plants during this stage that can be controlled or partially controlled by propagation system 200 including, for example: watering times, watering duration, watering frequency, the nutrients and nutrient levels supplied to the plants during each watering cycle, the pH level of the nutriated water, illumination times, illumination durations and illumination frequency, the ambient temperature at each rack, and the like.

A water supply subsystem can be integrated into the propagator station and include components distributed among each of pump house 220, center wall 230 and rack docks 240 portions of propagator station 210. The water supply system can supply nutriated water to propagation trays 310 occupying shelves within each rack dock 240 in propagator station 210. A water return subsystem can also be integrated into and include components distributed among each of pump house 220, center wall 230 and rack docks 240 portions of propagator station 210. The water return subsystem can return nutriated water from the propagation trays 310 to a holding tank in the pump house 220 and/or to divert the returned water to a water recycling station within the agricultural facility.

Generally, the propagator station 210, the set of racks 250 and the set of propagation trays 310, and the set of propagation cartridges cooperate to flood and drain each propagation tray 310 and provide required light to the plants in each propagation tray 310 according to set propagation schedules assigned to each rack 250. The different components of propagation system 200 can also cooperate to monitor, and adjust as necessary or appropriate, the conditions and levels of water dispensed to the plants in order to grow the seeds implanted into the propagation cartridges into seedlings ready for transfer into modules for distribution across a floor of the agricultural facility (e.g., to one of the farming blocks 110 within an automated agricultural facility 100). Propagator station 210 can also automatically fill and flush reservoirs within system 200 on an as needed basis.

Propagator station 210 can then illuminate these layers of grow media and the seeds contained therein and dose these layers of grow media with water and nutrients, such as by intermittently flooding these propagation trays with nutriated water over a period of time (e.g., 1-2 weeks), according to propagation schedules assigned to these racks, as these seeds grow into seedlings.

As one non-limiting example, many (e.g., 150) seeds can be manually or automatically dispersed through a layer of grow media that can be loaded into a single propagation cartridge 320. Multiple (e.g., twelve) propagation cartridges can be loaded into a single propagation tray 310, and multiple (e.g., four) propagation trays can be loaded onto different levels of a rack 250. Each rack 250 (e.g., eight racks, four on each side of center wall 230) can be loaded into respective rack docks 240 in the propagator station 210. The propagator station can therefore be loaded with 57,600 individual plants across 384 propagation cartridges, 32 propagation trays, and eight racks. Of course, these specific numbers are provided for illustrative purposes only. Embodiments disclosed herein are not limited to any particular number of seeds per propagation cartridge, any particular number of propagation cartridges per propagation tray, any particular number of propagation trays per rack or any particular number of racks and corresponding rack docks per propagator station.

Propagation system 200 can include various sensors (e.g, a set of ambient sensors, optical sensors, water sensors, etc.), a light element, a fan, a water supply connector or spigot, and/or a drain connector mounted to the center wall at each propagation tray location within each rack dock. The various components of propagation system 200 enable propagator station 210 to implement closed-loop controls to vary conditions that the seeds/seedlings are exposed to while residing within the propagator station. For example, propagation system 200 can very light intensity of light elements and speeds of fans within propagation tray locations in these rack docks based on light levels, temperatures, humidities, etc. read from sensors in these rack docks. The system 200 can also adjust pH and nutrient levels in the holding tank between flood cycles within these racks.

Furthermore, the propagator station 210 can: capture images of plants and grow media layers in these propagation trays via optical sensors arranged in these rack docks; scan these images for indicators of pests, heat burn, chemical burn, root rot, insufficient water, etc. in seedlings growing in these grow media layers; extract plant characteristics (e.g., sizes, foliage densities, growth rate) from these images; adjust propagation schedules (e.g., water qualities, lighting intensity and/or frequency, air flow rate) based on these indicators and plant characteristics; and selectively trigger an autonomous mover to move a rack from the propagation tray to a quarantine station in response to detecting pest indicators in a propagation tray in this rack.

1. Pump House (Holding Tank and Nutrient Dosing Subsystem)

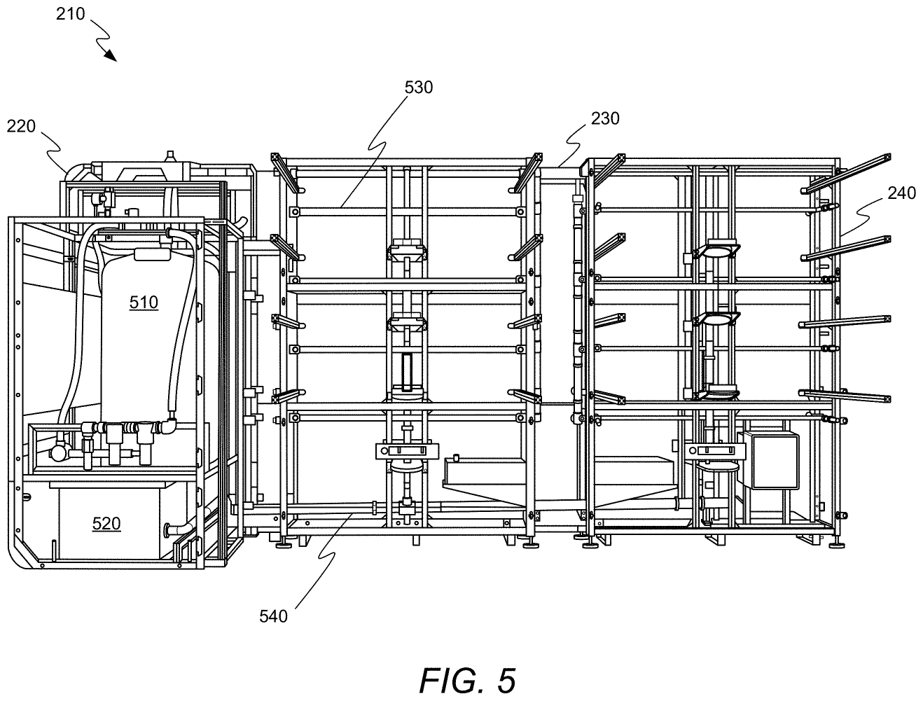

As shown in FIGS. 2-5, the propagator station 210 can include a pump house 220 in which various tanks, pumps and piping and other components are housed. In the depicted embodiment and with reference to FIG. 5, which is a simplified illustration of a portion of propagator station 210 (shown, for ease of illustration, without outer walls and other components), pump house 220 can include a nutriated water holding tank 510, a sump tank 520, an acid dosing system (not shown), a water supply subsystem 530 to deliver nutriated water from holding tank 510 to plants grown within the propagator station 210, and a set of water quality and/or fill level sensors (not shown) that are coupled to the holding tank.

In some implementations, the nutriated water holding tank can be coupled to a freshwater supply in the agricultural facility via a valve arranged between the holding tank and freshwater supply and the pump house can include a nutrient dosing subsystem (not shown) that can be coupled to the holding tank 510 to introduce nutrients into fresh water in the holding tank. In other implementations, nutriated water holding tank 510 can be coupled, by one or more valves, to receive pre-nutriated water from a nutrient mixing system within the agricultural facility instead of, or in addition to, being coupled to a nutrient dosing system within the pump house.

When included, a nutrient dosing subsystem can include a set of nutrient storage containers, multiple nutrient pumps configured to meter nutrients from the nutrient containers into holding tank 510, a mixing head (e.g., an agitator) configured to agitate water and nutrients loaded into the holding tank 510, and a pump (e.g., a flood pump) configured to pump a nutrient solution out of holding tank 510 and into the water supply subsystem. Similarly, the acid dosing subsystem, which in some embodiments can be part of the nutrient dosing subsystem, can include a container to store an acid solution, and one or more pumps configured to meter acid from the container to holding tank 510.

Pump house 220 can also include a set of water quality sensors arranged in or fluidly coupled to the holding tank, such as including: a pH sensor that outputs a signal representing pH of a water sample contained in the holding tank; a conductivity sensor that outputs a signal representing a concentration of ions, and therefore a measure of nutrient level, present in the water sample; a temperature sensor; a turbidity sensor that outputs a signal representing suspended solids in the water sample; an oxygen-reduction potential (or “ORP”) sensor that outputs a signal representing a level of oxidation/reduction reactions occurring in the water sample; a chlorine residual sensor that outputs a signal representing total chlorine in the water sample; and/or a total organic carbon (or “TOC”) sensor that outputs a signal representing total quality of the water sample.

In one implementation, these sensors are arranged in a base of holding tank 510 such that these sensors remain bathed in water even if the water level in the holding tank is low, thereby reducing opportunity for these sensors (e.g., especially the pH sensor) to dry out between flood cycles at the propagator station, which may affect calibration of these sensors.

Furthermore, the propagator station 210 can include multiple, redundant instances of these sensors and can discard anomalous results from redundant groups of like sensors or can average results from groups of like sensors when characterizing water quality in a module during a flood cycle, such as described below.

In one variation, the pump house 220 also includes a wastewater sump tank (520) configured to store nutriated water after a sequence of flood cycles through propagation trays in racks occupying the propagator station. In some embodiments, pump house 220 can also include a wastewater pump (or interfaces with another external pump within the agricultural facility) configured to move wastewater from the holding tank, from the sump tank 520, or directly from a water return subsystem 540 to a wastewater recycler within the agricultural facility. The wastewater recycler can then filter and sanitize this wastewater (e.g., via electrochemically-activated water, or “ECA”) and return a stream of fresh (e.g., potable) recycled water directly to the propagator station or store this freshwater in a freshwater tank connected to the propagator station. The wastewater recycler can also extract nutrients from the wastewater and package these nutrients for recycling or distribution back to the propagator station.

While only one side of propagator station 210 is visible in FIG. 5, in some embodiments, pump house 220 can include a separate nutriated water holding tank 510, a separate nutrient dosing subsystem, a separate acid dosing system, separate sump tanks 520, and separate water supply and water return subsystems for each of the two rows of rack docks 240 on the opposing sides of central wall 230.

2. Infrastructure, Central Wall and Rack Docks

Each rack dock 240 defines multiple propagation tray locations. For example, referring back to FIG. 3, two adjacent rack docks 240a and 240b are labeled with rack dock 240b having a rack 250b stationed within the rack dock 240b. As shown, each of rack docks 240a and 240b include four separate levels, which for ease of illustration are labeled within rack dock 240a only: bottom level 242, middle levels 244 and 246, and top level 248. Each of the levels 242, 244, 246 and 248 represents a location in a given rack dock 240 under which a propagation tray can be positioned. For example, FIG. 3 also shows a rack 250b that includes four separate levels 252, 254, 256 and 258 along with one propagation tray 310 on each level. Thus, each of the rack levels 252, 254, 256 and 258 is aligned with one of the rack dock levels 242, 244, 246 and 248. And, when a rack, such as rack 250b, is docked within a rack dock, such as rack dock 240b, the location within the rack dock at which each propagation tray sits can be referred to herein as a “propagation tray location”.

Referring now to FIG. 5, water supply lines (part of water supply subsystem 530) and water return lines (part of water return subsystem 540) can run through central wall 230 between the holding tank 510 and the propagation tray locations at the rack docks 240. High-current power lines can similarly run through the central wall 230 to lighting elements at each propagation tray location, and data (e.g., controls, sensor) lines can run through the central wall from sensors in the propagation tray locations to a central or common controller (not shown) within propagator station 210 that can be interaced with via a user interface 222, such as a computer screen and keyboard, on the propagator station or via an interface connected to the propagator station (e.g., over a wire or wireless network connection).

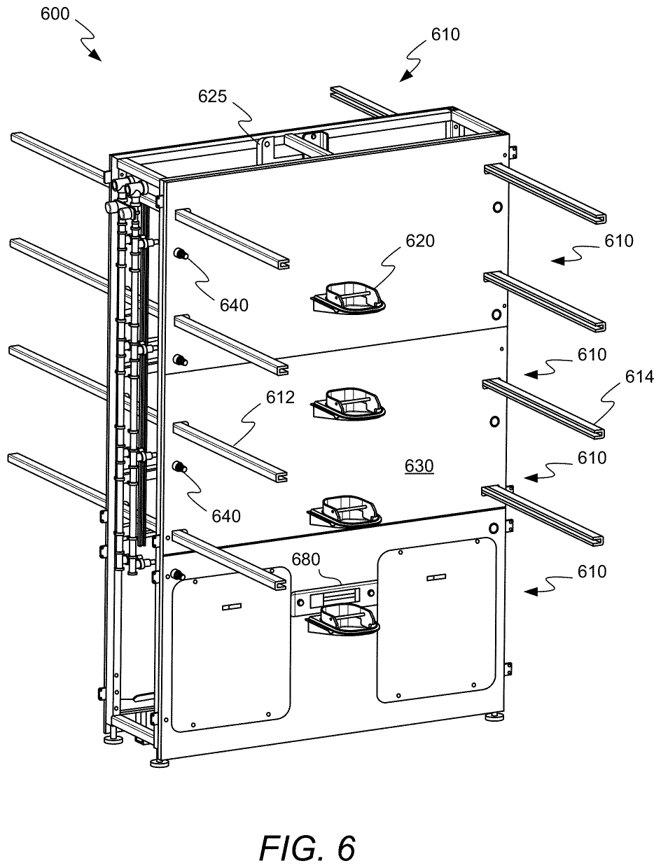

In some embodiments, central wall 230 can be assembled from multiple, separate wall sections. FIG. 6 is a simplified perspective view of one such wall section 600 according to some embodiments. Wall section 600 can be incorporated into a propagator station 210, and in some embodiments there is a wall section 600 for every two rack docks 240, one rack dock 240 on a first side of wall section 600 and a second rack dock 240 on a second side of wall section 600, opposite the first side.

Wall section 600 includes four propagation tray locations 610 on each of its two sides and, in the embodiment of propagator station 210 depicted in FIGS. 2-5, there are thirty-two propagation tray locations in total. Each propagation tray location 610 can include a drain assembly 620 that is fluidly coupled to water return subsystem 540. Drain assembly 620 can extend through cutouts made in a wall panel 630 that provides a skin or outer surface to central wall 230 hiding piping and wiring that runs through the central wall to each of the rack docks 240. As shown, in some embodiments wall panel 630 can multiple separate panels 630 attached to a frame of the central wall section 230.

Each drain assembly 620 can include a bowl that, when a rack is properly docked at a rack dock within wall section 600, is positioned directly under, or in contact with, a drain port of the propagation tray positioned at that level. Drain assembly 620 can feed nutriated water, drained from a propagation tray positioned directly above the drain assembly, into the water return subsystem 540.

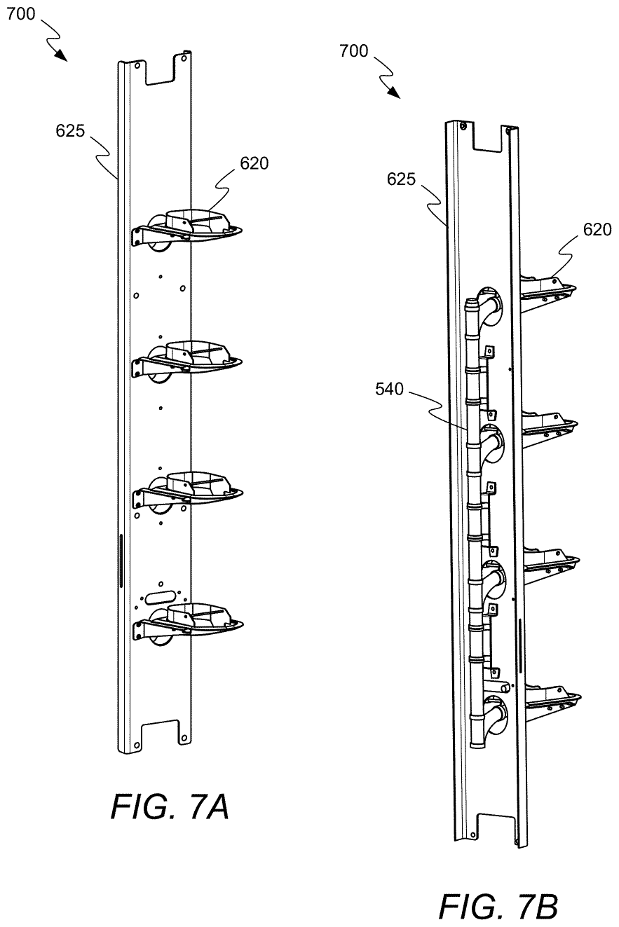

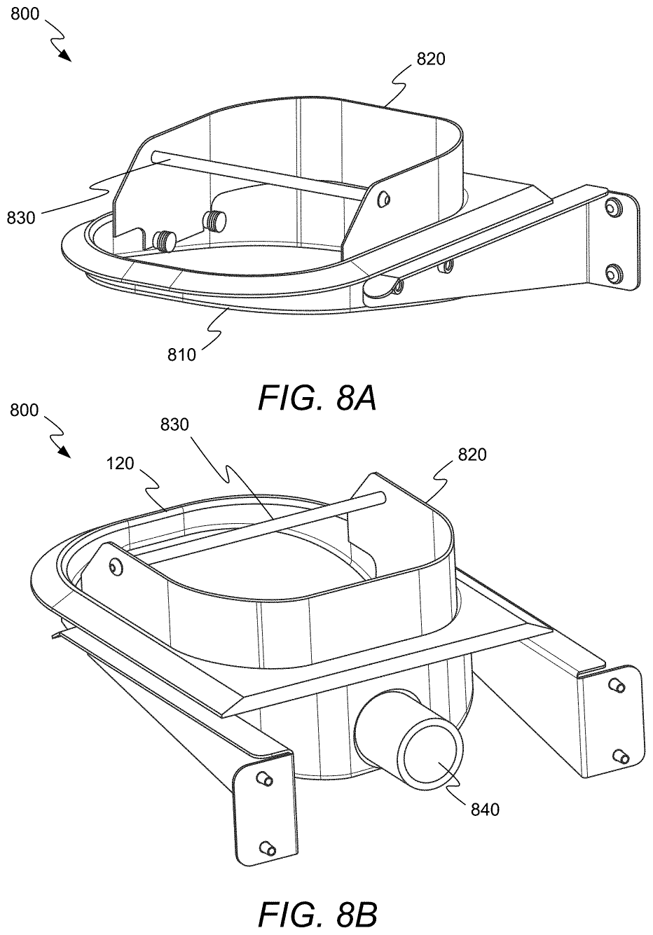

To illustrate, reference is made to FIGS. 7A and 7B, which are simplified front and rear perspective views, respectively, of a central section 700 that can be a portion of wall section 600. As shown, central section 700 includes a support plate 625 (also shown in FIG. 6) that can be attached (e.g., bolted) to a framing structure of central wall 230. Each drain assembly 620 can then be attached to support plate 625 such that the drain assemblies extend outward into each propagation tray location. Piping that is part of water return subsystem 540 is coupled to a bowl portion (e.g., bowl 810 shown in FIGS. 8A and 8B discussed below) of each drain assembly to direct nutriated water drained from the individual propagation trays at each propagation tray back to pump house 220.

Each propagation tray location 610 can also include a water supply connector 640 (shown in FIG. 6) that is fluidly coupled to water supply subsystem 530. Water supply connector 640 can extend from wall panel 630 to a position at which, when a rack is properly docked at a rack dock within wall section 600, the water supply connector 640 is positioned directly over, or in direct contact with, a fill port of the propagation tray positioned at that level. Water supply connector 640 can be configured to feed nutriated water from the water supply subsystem 530 into its respective propagation tray 310 via the fill port. Alternatively, each propagation tray location 610 in the propagator station can include a water supply spigot that extends from wall panel 630 over an edge of a respective propagation tray 310 positioned within the propagation tray location 610 and can be configured to feed nutriated water from the water supply subsystem 530 into the propagation tray.

Each propagation tray location 610 can also include a light element (e.g., an LED or infrared light) that is located at a position directly above the location at which a propagation tray, when docked properly within the rack dock, is positioned at location 610. Thus, light element is also positioned directly above drain assembly 620 and water supply connector 640. A shelf (shown in FIG. 11 as shelf 670) can extend between first and second opposing supports 612, 614 at each propagation tray location 610. The light element (not shown in FIG. 6, but shown in FIG. 15) can be attached to the lower portion of each shelf. When a rack 250 is docked at a rack dock 240, the propagation trays 310 on the rack are positioned below each shelf of the rack dock so that the lighting element of each shelf can direct light towards seeds or plants growing in the propagation trays 310 beneath the lighting elements.

While not shown in FIG. 6, each propagation tray location in the propagator station can also include a set of ambient sensors, such as a temperature sensor, a humidity sensor, a light level sensor, and/or an airflow sensor. Similarly, each propagation tray location in the propagator station can include an optical sensor configured to capture an optical image (e.g., a color photographic image, a thermal image, a depth image) of plants in propagation cartridges in the adjacent propagation tray. For example, ambient and optical sensors in a first propagation tray location in a first rack dock can be arranged on the underside of a second drain connector of a second propagation tray location immediately above the first propagation tray location in the first rack dock.

In one implementation, the propagator station activates light elements on each shelf 670 within a rack dock according to intensities, temperatures, frequencies, and/or durations specified in a propagation schedule assigned to a rack docked at the rack dock. The propagator station can also track humidity, temperature, airflow rate, light level, etc. within the rack dock generally and/or over each propagation tray within the rack; and control light elements and fans in the rack dock (or at each propagation tray location in the rack dock specifically) to maintain target humidities, In various embodiments, propagation schedules (e.g., light intensity, light duration, light frequency, air flow rate, humidity, nutrient dosing schedules, and other controllable variables that effect plant growing conditions) can be assigned to the propagator station 210 as a single unit, assigned to individual rack docks 240 within the propagator station 210 or assigned to individual propagation tray locations 610 within each rack dock 240. For example, in various embodiments, propagation schedules can be assigned throughout propagator 210 on a system wide level, assigned on a rack dock basis where the same propagation schedule is implemented at each propagation tray location within a given rack dock but different propagation schedules can be implemented in other rack docks 240 within the propagator station 210, or assigned based on individual propagation tray locations so that adjacent tray locations 610 in the same rack dock 240 can have varied propagation schedules.

In the embodiment depicted in FIG. 6, each rack dock 240 in the propagator station 210 can include a first latch component 680 that is part of a latching system (e.g., a mechanical or magnetic latch) configured to engage a mating component mounted on a rack (e.g., rack 250) occupying the rack dock, to draw the rack into the rack dock. Once latch component 680 mates with (i.e., engages with) its corresponding component on the rack, the propagation trays 310 on the engaged rack are properly aligned and positioned within each propagation tray location thus aligning drain assembly 620 with drain ports in the propagation trays 310 and aligning the water supply connector 640 or water supply spigot with the propagation trays 310 so that the trays can be properly filled with nutriated water.

In some embodiments, latch component 680 is an electromagnet and each rack 250 includes an armature plate (i.e., a ferromagnetic plate that can be magnetically attracted to the electromagnet) that is aligned on the rack to be directly adjacent the electromagnet when the rack is moved into its proper position at the rack dock. In other embodiments, latch component 680 and its corresponding component on a rack can be two complementary components of any appropriate latch system including, as non-limiting examples, a deadbolt latch, a spring latch, a mechanical cam lock, an electronic cam lock, toggle latch, and the like.

Latch component 680 can be attached to wall panel 630 directly above one of the drain assemblies 620. As depicted, latch component 680 is shown at the bottom propagation tray location of wall section 600. Other embodiments can include a latch component 680 positioned at different propagation tray locations or can include multiple latch components 680. In alternative embodiments (not shown), each propagation tray location can include a latch component (e.g., a mechanical or magnetic latch component) configured to engage the adjacent propagation tray, to draw the propagation tray into the rack dock, and seal the fill and/or drain ports in the propagation tray against corresponding fill and/or drain connectors in the rack dock.

Reference is now made to FIGS. 8A and 8B, which are simplified front and rear perspective views, respectively, of a drain assembly 800 that can incorporated into wall section 600. Drain assembly 800 can be representative of drain assembly 620 discussed above. Drain assembly 800 can include a bowl 810 that, when a rack is properly docked at the rack dock in which the drain assembly is positioned, it located directly under, or in contact with, a drain port of the respective propagation tray. A collar 820 can surround a portion of the periphery of bowl 810 to act as a splash guard that helps ensure that all the water drained from the propagation tray goes directly into bowl 810.

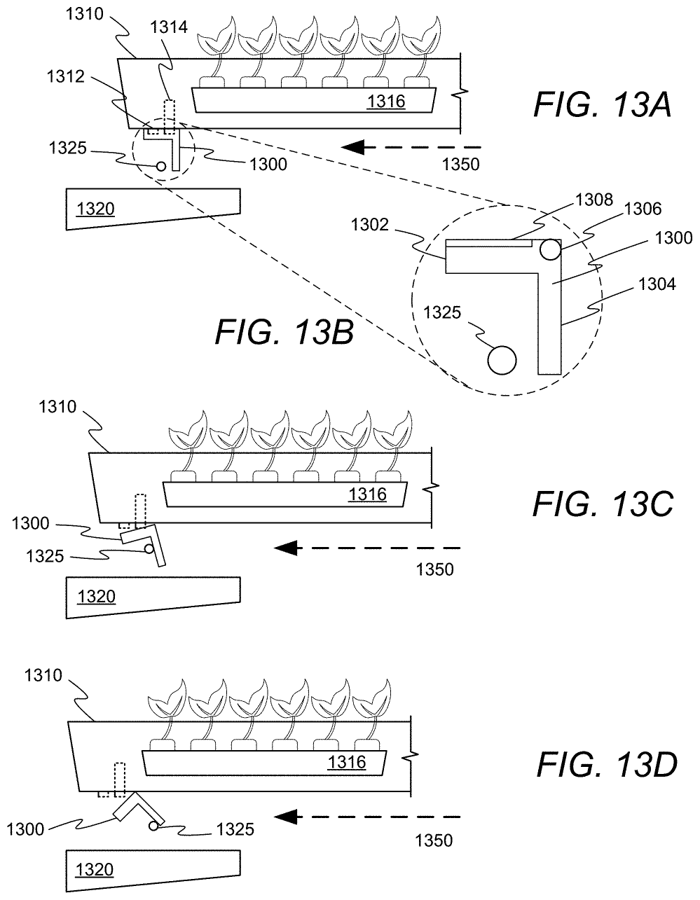

Drain assembly 800 also includes a rod 830 and a drain coupling 840. Rod 830 is fixedly coupled to collar 820 and positioned to trigger the opening of a stopper coupled to the bottom of a propagation tray 310 during the process in which the propagation tray is moved into (i.e., docked with) the rack dock 240 in which drain assembly is positioned as discussed in more detail in conjunction with FIGS. 13A to 13D. Bowl 810 directs water received at the drain assembly (e.g., nutriated water passed through a propagation tray disposed over drain assembly 800) to the drain coupling 840 which routes the water to water return subsystem 540 enabling nutriated water drained from a propagation tray positioned directly above the drain assembly 800 to be delivered back to pump house 220.

3. Rack and Propagation Trays

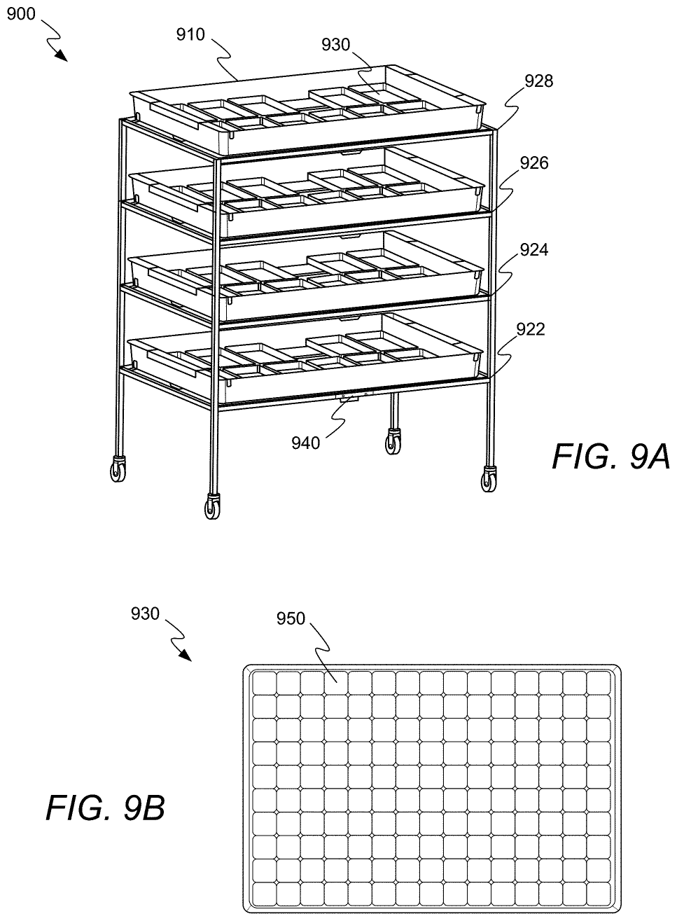

FIG. 9A is a simplified perspective view of a rack 900 according to some embodiments that can be used in conjunction with seed propagation systems disclosed herein. Rack 900 can be representative of rack 250 discussed above. Also shown in FIG. 9A is a set of propagation trays 910 (representative of propagation trays 310) that can be transported to and from propagator station 210 on rack 900. Rack 900 includes multiple levels, each of which is configured to locate a propagation tray, and is sized and shaped for insertion into a rack dock 240 in the propagator station by an autonomous mover (or a human operator). As shown, rack 900 includes four levels 922, 924, 926 and 928 that are aligned with the four shelves of propagator station 210. Each level is in essence a shelf on rack 900 and can include a flat support structure (e.g., a metal plate or bars that extend across the level) that can support a propagation tray positioned at the level. The bottom level While rack 900 is depicted as including four levels, it is to be understood that the number of levels in rack 900 (and the number of shelves in propagator station 210) is implementation specific and other embodiments can include fewer than or more than four levels and four shelves.

In the depicted implementation, rack 900 includes a mobile, wheeled structure supporting a column of propagation trays at a target vertical pitch distance. For example, the vertical pitch distance can be approximately equal to a sum of: a height of the propagation trays; a maximum height of a seedling above a propagation tray at the end of a seeding stage at the propagator station; a height of light elements extending outwardly from the center wall of the propagator station at each propagation tray location; a minimum offset distance between a light element and seedlings in a propagation tray at a propagation tray location within a rack dock; and a minimum air gap, for convective heat transfer, between the top of a light element and the bottom of a propagation tray arranged thereover in a rack dock in the propagator station. In one particular example, propagation trays can be 8″ in height; the maximum seedling height can be about 2″ above the side of a propagation tray; light elements can be 4″ in height; a minimum offset distance between light elements and seedlings can be set at 4″; and the minimum air gap between the top of a light element and the bottom of an adjacent propagation tray can be set at 4″. Accordingly, the rack can locate propagation trays at a vertical pitch distance of 24″ in this particular example.

In some embodiments, the bottom level of rack 900 (i.e., level 922) is sufficiently strong that an autonomous mover can move underneath rack 900 and lift the rack off the ground (e.g, by several inches) by extending a lift from the autonomous mover up to the bottom level of the rack. Once lifted in this manner, the autonomous mover can deliver the rack to any appropriate location witin agricultural facility 100, such as one of rack docks 240 where the lift can be lowered and rack 900 can be supported by its legs (which in some embodiments can include wheels).

In some embodiments rack 900 can include a latch element 940 and an unique optical fiducial (e.g., a QR code). Latch element 940 can configured to engage a mating structure (e.g., first latch component 680 shown in FIG. 6) in one of rack docks 240 of propagator station 210 in order to align and secure rack 900 within the rack dock. For example, when first latch component 680 is an electromagnet, latch element 940 can be an armature plate (i.e., a flat plate made from a ferromagnetic material that will clamp onto the electromagnet when the electromagnet is energized and the rack is properly positioned within its rack dock.

The optical fiducial (not shown in FIG. 9A) can be positioned on rack 900 to be visible to an optical sensor (e.g., a color camera) in the propagator station to uniquely identify the rack to the propagator station. Once identified, propagator station 210 can register the rack within its memory (e.g., a computer-readable memory accessible to the control software of propagator station 210) and use information about the rack and the contents of the various propagation trays 930 within the rack to implement either rack-specific or propagation tray-specific propagation schedules for the particular rack and the propagation trays positioned on the rack.

Each propagation tray 910 is sized and shaped to be loaded onto one of the levels (e.g., levels 242, 244, 246 or 248 discussed above) of a propagation rack and can hold multiple propagation cartridges 930. For example, in the depicted embodiment, each propagation tray 910 can hold twelve propagation cartridges 930 positioned within the tray 910. Each propagation cartridge can be a perforated tray that contains a layer of grow media populated with plant seeds. FIG. 9B is a simplified top plan view of a propagation cartridge 930 according to some embodiments. Propagation cartridge 930 includes an array of plugs 950 where each plug contains a growing medium implanted with one or more seeds. In the depicted embodiment, propagation cartridge 930 includes ten rows and fifteen columns of plugs 950 for a total of 150 plugs that enable 150 separate plant units to be grown in propagation cartridge 930.

In one variation, agricultural facility 100 can include a seeding station (e.g., located in processing bays 110) in which a robotic seeding manipulator loads a layer of grow media into a propagation cartridge that defines a perforated tray and injects seeds into the layer of grow media. The layer of grow media can be in the form of the array of plugs 950 shown in FIG. 9B. In some implementations, a single seed can be loaded into each plug (thus enabling 150 plants to be grown in propagation cartridge 930 while in other embodiments multiple seeds (e.g., 2-6 can be loaded into each plug to better ensure that one or more seedlings can be grown (as 150 plant units, rather than 150 individual plants) while the cartridge 930 resides in propagator station 210.

The robotic seeding manipulator can repeat the seeding process to populate each propagation tray within a set of (e.g., twelve) propagation cartridges, load the propagation tray into a level of the rack and repeat the seeding process to load remaining levels in the rack with propagation trays populated with propagation cartridges and seeded grow media layers. This process can then be repeated to fill additional racks with propagation trays populated with propagation cartridges and seeded grow media layers as needed to populate every propagation cartridge 930 in every propagation tray 910 loaded onto every rack 250 that is docked at every rack dock 240 of a propagator station 210. Additionally or alternatively, some or all of the seeding process can be completed manually by one or more human operators at the seeding station.

a) Integral Fill and Drain Ports with Overflow Drain

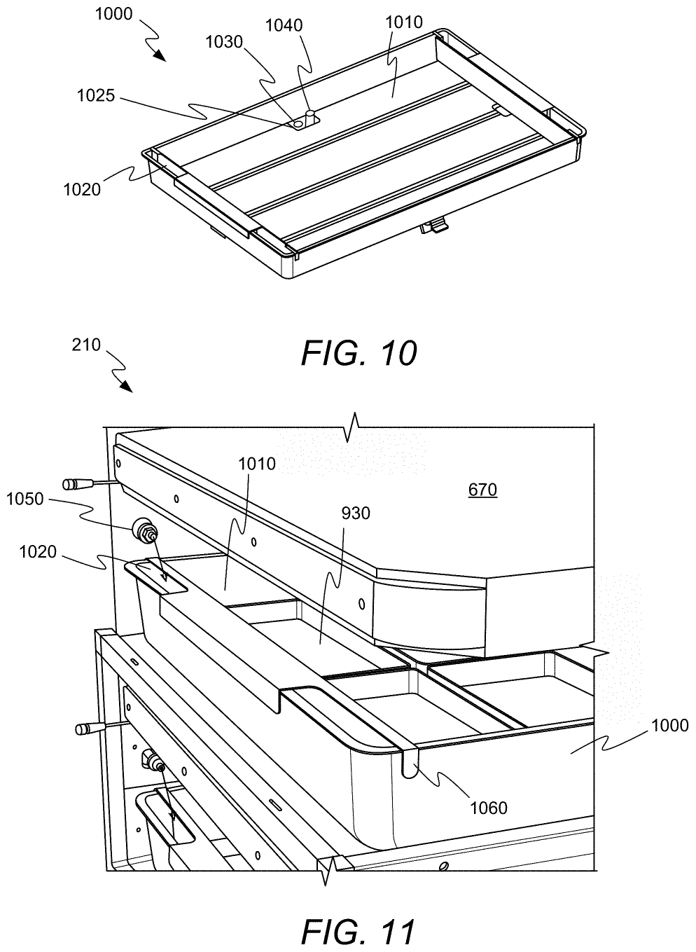

Reference is now made to FIG. 10, which is a simplified perspective view of a propagation tray 1000 according to some embodiments, and FIG. 11, which is simplified perspective view illustration of a portion of seed propagation tray 1000 positioned within seed propagation system 210. Propagation tray 1000 can be representative of propagation tray 910. As shown in FIGS. 10 and 11, propagation tray defines a basin 1010 in which multiple propagation cartridges (e.g., propagation cartridges 930) can be placed, a fill port 1020 arranged along a side of the tray, a drain port 1030 arranged in a sump or trough 1025 in the base of the propagation tray, and an overflow drain port 1040 adjacent to drain port 1030. Overflow drain port 1040 defines an inlet at a maximum water fill level in basin 1010. Fill port 1020 can align with or connect to a water supply line 1050 (e.g., water supply connector 640) within the water supply subsystem 530 of the propagator station, drain port 1030 can connect to the water return line via a drain valve, and overflow drain port 1040 can connect directly to a water return line in the propagator station.

In the depicted implementation: fill port 1020 can be partially separated from the remainder of basin 101 by a barrier wall 1060 that extends across the width of the propagation tray. Barrier wall 1060 can have height that is less than a depth of basin 1010 such that a bottom portion of barrier wall 1060 is spaced apart from a bottom surface of basin 1010 allowing water to flow from fill port 1020, under barrier wall 1060, into the area of basin 1010 where the propagation cartridges are positioned. In this manner barrier wall 1060 acts as a dividing barrier between the two regions to reduce the creation of waves or sloshing of water within basin 1010 during a flood cycle.

During a flood cycle, the propagator station can close a valve that controls water flow through drain 1030 and supply nutriated water to the propagation tray 1000 via the water supply line 1050. The propagation tray 1000 then fills basin 1010 with nutriated water up to overflow drain port 1040 and water entering the propagation tray in excess of the target fill level drains from the overflow drain port back to the holding tank or wastewater tank (e.g., sump tank 520). Once basin 1010 within the propagation tray 1000 is flooded for a target saturation duration, propagator station 210 opens the valve to drain 1030 to drain nutriated water from propagation tray 1000 back into the holding tank or into the wastewater tank.

In this and in some other implementations, instead of or in addition to overflow drain 1040, propagation tray 1000 can also include a fill float valve (not shown) that is operatively coupled to fill port 1020. The fill float valve can be open in a default position when the propagation tray is not filled with water and configured to close to stop water flow into the propagation tray via fill port 1020 when a volume of water in the propagation tray 1000 reaches a target fill level thereby raising the float of the fill float valve. Therefore, in this implementation, propagator station 210 can supply nutriated water to propagation tray 1000 via fill port 1020 during a flood cycle, and the fill float valve can prevent overfilling of nutriated water in the propagation tray during this flood cycle.

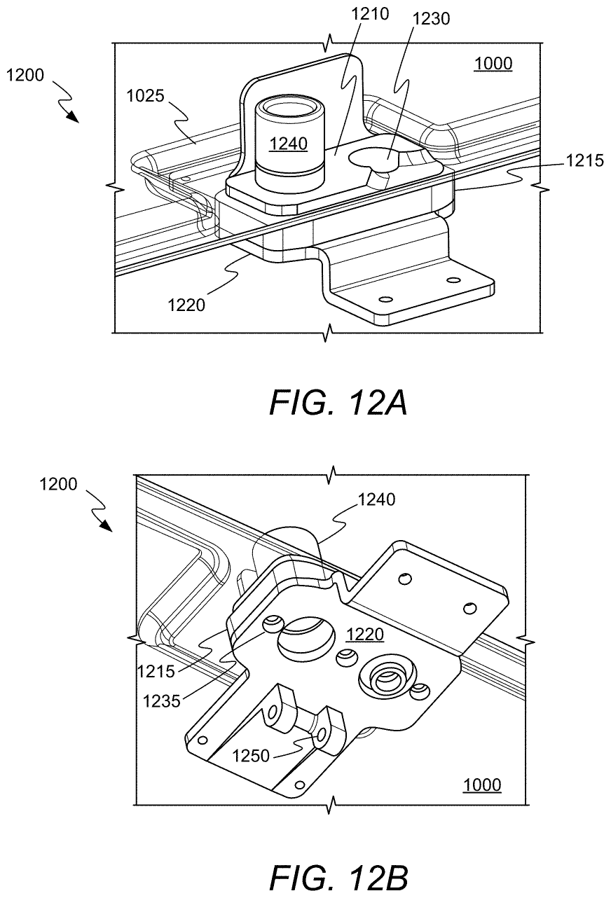

In some embodiments, propagation tray 1000 includes two circular holes in the trough 1025 through which a drain port assembly is fitted. To illustrate, reference is made to FIGS. 12A and 12B, which are simplified top and bottom perspective views of a drain port assembly 1200 according to some embodiments. Drain port assembly 1200 can include upper and lower plates 1210, 1220, respectively, that are attached to opposing surfaces of propagation tray 1000. The plates 1210, 1220 can be made from any appropriate rigid material including metal (e.g., stainless steel) or plastic.

Upper plate 120 can be placed over the two circular holes in trough 1025 such that a drain port 1230 (which can be representative of drain port 1030) is directly over one of the circular holes and a overflow drain port 1240 (which can be representative of overflow drain port 1040) is positioned over the other circular hole. The upper plate can be affixed to lower plate 1220 via fasteners (not shown) that extend through the lower plate 1230 into the upper plate 1220 via fastener holes 1235. In some embodiments, including the embodiment depicted in FIGS. 12A and 12B, drain port assembly 1200 can also include a middle plate 1215 that is sandwiched between the upper and lower plates 1210 and 1220. Both middle plate 1215 and lower plate 1220 have holes through their upper and lower surfaces that align with the drain and overflow ports 1230 and 1240.

As noted above, during operation of propagator station 210, propagation trays are moved into and out of the rack dock. The propagation trays can include a sloped bottom surface within basin 1010 along with various channels formed at the bottom surface that, during a drain cycle, direct water to the sump region 1220 and directly drain 1230 to ensure as much of the nutriated water exits basin 1210 as possible. The propagation trays 1210 can be moved out of propagator station 210 (and thus out of the rack docks 240) when the seedlings growing within the propagation trays of a given rack are ready to be transferred to a next phase of their agricultural cycle. At this time, any residual water within the trays can potentially drip out of the drain ports 1230 contaminating or otherwise dirtying the rack dock and/or floor of the agricultural facility. To prevent this, some embodiments include a pivotable stopper that covers drain port 1230 when the drain port tray is not positioned directly over drain assembly 620. To illustrate, reference is made to FIGS. 13A-13D, in which are simplified illustrations depicting the operation of a pivotable stopper 1300 in accordance with some embodiments.

FIG. 13A shows a portion of a propagation tray 1310 positioned above a drain assembly 1320. Propagation tray 1310 can be representative of propagation tray 1000 and drain assembly 1320 can be representative of drain assembly 800. As depicted, the propagation tray 1310 includes a drain port 1312 and an overflow drain port 1314. A propagation cartridge 1316 is positioned within a basin of the tray and the tray is in the process of being docked in a rack dock within a propagator station (e.g., one of rack docs 240 in propagator station 210) by being moved in the direction of arrow 1350 to towards a final, docked position.

FIG. 13B is an expanded view of a highly simplified representation of pivotable stopper 1300. As shown, pivotable stopper includes a sealing plate 1302 that is pivotably coupled to a catch plate 1304 by a hinge 1306. Stopper 1300 can be biased in a closed position by a spring (now shown) or similar structure that forces sealing plate 1302 against a bottom surface of propagation tray 1310. Sealing plate 1302 extends over both drain port 1312 and overflow drain port 1314 to prevent any residual water or other liquid that may be within the basin of propagation tray 1310 from dripping or otherwise leaking out of the basin. In some embodiments, sealing plate can be a metal or otherwise rigid plate that includes a gasket 1308 made from a flexible sealing material having a lower durometer (e.g., an elastomeric material, such as silicone or a natural rubber) to create a water tight seal across drain port 1312 and overflow drain port 1314 when pivotable stopper 1300 is in the closed position.

Referring now to FIG. 13C, as propagation tray 1310 is moved in direction 1350 closer to a final docked position, catch plate 1304 comes in contact with a trigger rod 1325 that can be part of drain assembly 1320 (for example, trigger rod 1325 can be representative of rod 830 shown in FIGS. 8A and 8B). The physical contact between catch plate 1304 and trigger rod 1325 cases stopper 1300 to begin to pivot along the axis defined by hinge 1308 until the propagation tray reaches its final docked position (shown in FIG. 13D) in which sealing plate 1302 is pivoted further away from the drain and overflow drain ports allowing water (e.g., nutriated water within the basin of propagation tray 1310) to drain from one or both of drain port 1312 and overflow drain port 1314 into the drain assembly 1320. Since pivotable stopper 1300 is biased to a closed position, once propagation tray 1310 is moved out of the rack dock (i.e., in the direction opposite direction 1350, the piovtable stopper rotates back to a closed position sealing the drain and overflow drain ports 1312, 1314 to prevent water dripping out of the propagation tray as the propagation tray is transported to a new location within agricultural facility 100.

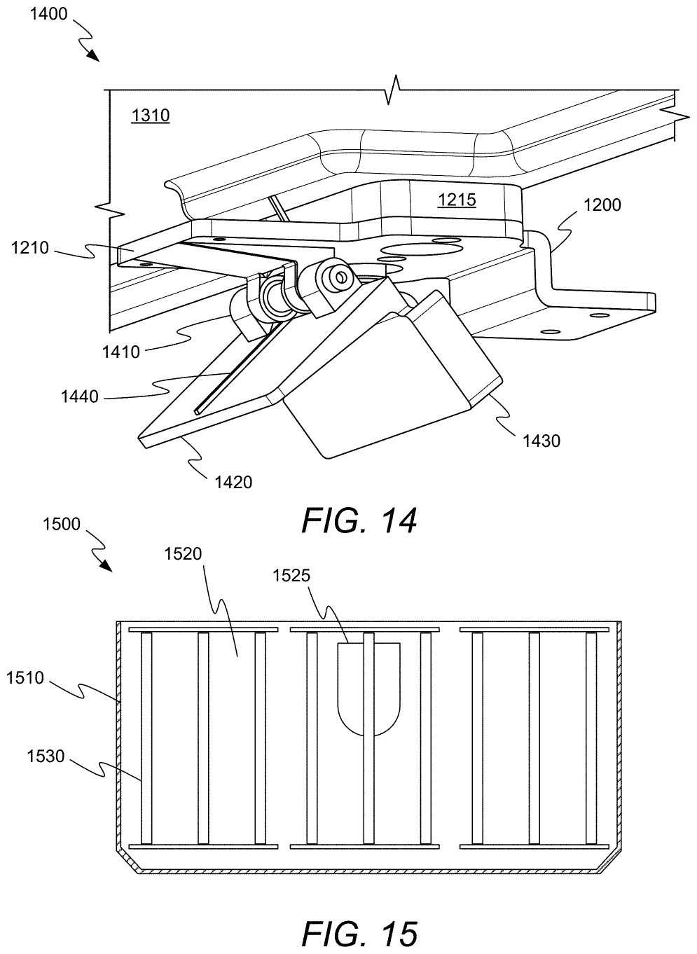

Referring back to FIG. 12B, drain port assembly 1200 includes opposing holes 1250 that are part of the hinge 1308 which allows pivotable stopper 1300 to be attached to the drain port assembly. Further details of a pivotable stopper that can be attached, via a hinge that includes a rod extending through the opposing holes 1250, to drain port assembly are discussed in conjunction FIG. 14, which is a simplified perspective view of drain port assembly 1200 coupled with a pivotable stopper 1400 that can be representative of pivotable stopper 1300 discussed above.

As shown in FIG. 14, pivotable stopper 1400 is rotationally coupled to drain port assembly 1200 at hinge 1410 (of which opposing holes 1250, not directly visible in FIG. 14, are part of). The stopper includes a catch plate 1420 and a sealing plate 1430. As depicted in FIG. 14, stopper 1400 is at an intermediate stage of rotation, between an open and closed position. Stopper 1400 can be biased by a torsion spring 1440 in a closed position (e.g., as shown in FIG. 13A). When closed, stopper 1400 covers drain port 1230 and overflow port 1240 to prevent residual water from leaking out of basin 1210 when the propagation tray is moved away from rack dock 240. When opened (for example, when catch plate 1420 is pushed backwards after coming in contact with trigger rod 1325), water can drain from drain port 1230 and overflow drain port 1240 into the water return subsystem (e.g., into bowl 810 which leads to the water return subsystem 540 via drain coupling 840).

b) Integral Fill and Drain Ports

In some implementations overflow drain 1040 is not included. For example, fill port 1020 can connect to a water supply line (e.g., line 1050 that is part of water supply subsystem 530) in propagator station 210 and drain port 1030 can connect to a water return line (e.g., water return subsystem 540). A drain valve (not shown) in propagator station 210 can open and close drain 1030. Accordingly, during a flood cycle, propagator station 210 can: close the drain valve and supply nutriated water to propagation tray 1000 via the water supply line until a target water fill level is reached in propagation tray 1000 as detected by a fill sensor (e.g, a SONAR or LIDAR depth sensor arranged in the propagation tray location of the propagator station occupied by the propagation tray). After a target saturation duration in which the grow media in the propagation tray is soaked with nutriated water, propagator station 210 can open the drain valve to drain nutriated water from propagation tray 1000 back into the holding tank or into sump tank 520 in the propagator station.

In this implementation, the propagation tray can also include a fill float valve coupled to the fill port and open in a default position when the propagation tray is not filled with water. The fill float valve can be configured to close to stop water flow into the propagation tray via the fill port when a volume of water in the propagation tray, approaching a target fill level, raises a float of the fill float valve. Therefore, in this implementation, the propagator station can supply nutriated water to the propagation tray via the fill port during a flood cycle, and the fill float valve can prevent overfilling of nutriated water in the propagation tray during the flood cycle.

Additionally or alternatively, the propagation tray can include a drain float valve coupled to the drain port. The drain float valve can be closed in a default position and configured to open to enable water to exit the propagation tray via the drain port when a volume of water in the propagation tray, approaching a target fill level, raises a float of the drain float valve. Therefore, in this implementation, the propagator station can supply a continuous feed of nutriated water to the propagation tray via the fill port during a flood cycle, and the drain float valve can release water, in excess of a target fill level, out of the propagation tray via the drain port during this flood cycle.

c) Integral Bidirectional Fill Port and Overflow Drain

In yet another implementation, the propagation tray includes a fill port arranged in a sump or trough in the base of the propagation tray and a drain port arranged in a base or side of the propagation tray and defining an inlet at a maximum water fill level in the propagation tray. In this implementation, the fill port can connect to the water supply line in the propagator station and the drain port can connect to the water return line in the propagator station defining an inlet at a target water fill level in the propagation tray. During a flood cycle, the propagator station can supply nutriated water to the propagation tray via the water supply line; the propagation tray can fill with nutriated water up to the overflow drain; and water entering the propagation tray in excess of the target fill level enters the overflow drain and returns to the holding tank or wastewater tank (e.g., sump tank 520). Once the propagation tray is flooded for a target saturation duration, the propagator station drains nutriated water drained from the propagation tray via the fill port, such as: by reversing a pump, coupled to the water supply line in the propagator station, to actively pump nutriated water out of the propagation tray and back into the holding tank; and/or by triggering a valve in the water supply line to redirect nutriated water into a wastewater tank or directly to a recycling station within the agricultural facility.

d) Integral Drain Port and/or Overflow Drain

In another implementation, the propagation tray includes a drain port and an overflow drain. In this implementation, the propagator station can include a set of spigots coupled to a water supply line and a drain connector that mates with the drain port and the overflow drain (e.g., via a single outlet in the propagation tray) to drain water exiting the propagation tray back to the holding tank or to a wastewater tank (e.g., sump tank 520). The set of spigots can extend from the rack dock and be offset by the vertical propagation tray pitch distance such that the propagator station includes a spigot extending over each propagation tray in a rack loaded into the rack dock. Furthermore, when the propagation tray is loaded into a propagation tray location in the propagator station, the propagator station can extend the spigot outwardly from the center wall to locate the spigot over an edge of the propagation tray and the drain port and the overflow drain in the propagation tray can connect to a drain connector in this propagation tray location.

During a flood cycle, the propagator station can supply nutriated water to the propagation tray via the water supply line and the spigot. The propagation tray thus fills with nutriated water up to the overflow drain, which drains water in excess of a target fill level of the propagation tray back to the holding tank. Once the propagation tray is flooded for a target saturation duration, the propagator station opens a drain valve coupled to the drain port to drain nutriated water from the propagation tray back into the holding tank.

Alternatively, in this implementation, the propagation tray can include a drain port and a drain float valve. Accordingly, the propagator station can dispense nutriated water into the propagation tray via the spigot and the drain float valve can open to release excess nutriated water in the propagation tray back to the holding tank when the water level in the propagation tray approaches the target fill level thus raising the float of the drain float valve. The propagator station can then open the drain valve, coupled to the drain port, to empty the propagation tray upon conclusion of the target saturation duration during this flood cycle.

Yet alternatively, in this implementation, the propagation tray can include a drain port only, and the propagator station can dispense a controlled volume of nutriated water into the propagation tray via a spigot in the rack dock and then open a drain valve coupled to the drain port to empty the propagation tray upon conclusion of the target saturation duration during a flood cycle.

e) Integral Drain Port Valve

Furthermore in the foregoing implementations of the propagation tray that include a drain port, the propagation tray can include an integral drain port valve coupled to the drain port. The valve can be closed by default and operable by the propagator station, via an actuator (e.g., a solenoid) in a propagation tray location within a rack dock, to open the drain port valve and release nutriated water from the propagation tray back to the holding tank via the water return line.

Thus, in this implementation, the propagator station can include an actuator configured to operate a drain port valve and a cup, extending under a drain port and configured to feed nutriated water from the drain port to the water return line, at each propagation tray location within each rack dock.

4. Shelves and LED Lighting

FIG. 15 is a simplified bottom plan view of a shelf 1500 that can be positioned within a rack dock of a seed propagation system according to some embodiments. Shelf 1500 includes a frame 1510, a top plate 1520 and a lighting element 1530, which can be attached to frame 1510 and/or top plate 1520 by any appropriate means, such as screws or other fasteners. Lighting element can be any appropriate lighting device that can deliver radiation to seeds or seedlings growing within a propagation tray positioned below the lighting element. In some embodiments, lighting element 1530 is spaced several inches below top plate 1520 in order to accommodate various electrical wires and/or a drain assembly as discussed below. In the depicted embodiment, lighting element 1530 includes nine rows of LED lights that are spaced apart from each other at even intervals along a length of shelf 1500.

While not shown in FIG. 15, each shelf 1500 can also include one or more optical sensors that can capture images of a propagation tray (and its contents) directly below the shelf along with one or more other sensors, such as a thermometer, an airflow sensor, and/or other sensors described herein.

Top plate 1520 can define an upper surface of shelf 1500 and, in some shelves in a propagator system, top plate 1520 includes a cutout 1525 that fits around an accommodates a drain assembly, such as drain assembly 800 discussed above. Each propagation tray location (e.g., propagation tray locations 610) in propagator station 210 can include a shelf, such as shelf 1500, at an upper boundary of the propagation tray location. Thus, in essence, shelf 1500 defines both an upper boundary of some propagation tray locations and/or a lower boundary of other propagation tray locations. Shelf 1500 can be representative of each middle shelf in a rack dock in a given propagator station. A bottom most shelf at each rack dock can be similar to shelf 1500 but, since no propagation tray location is beneath the bottom shelf, need not include a lighting element 1530. A top most shelf at each rack dock can also be similar to shelf 1500 but, since there is no propagation tray location above the top shelf, need not include a cutout section 1525 that would accommodate a drain assembly as shown in FIG. 15.

5. Rack Loading at Propagator Station

As described in U.S. patent application Ser. No. 15/872,299, the agricultural facility can also include a mover (e.g., an autonomous vehicle) configured to autonomously: navigate to the seeding station; navigate to and engage a rack at the seeding station (e.g., lift a rack off the ground); navigate to a rack dock in the propagator station assigned to the rack; navigate the rack into the assigned rack dock, such as according to a seeding schedule assigned to this rack (and the seeds contained therein) by an agricultural facility scheduler; disengage from the rack (e.g., lower the rack to the ground); and navigate to a new location to begin a next task, such as delivering a second rack from the seeding station to a different rack dock at the propagator station.

Upon receipt of a new rack from the seeding station, the propagator station can check propagation trays in the rack for pests. For example, in one implementation, the propagator station: captures an optical image (e.g., a color photographic image, a thermal image) of each propagation tray (or each propagation cartridge in each propagation tray more specifically) in the rack via optical sensors arranged in propagation tray locations within the rack dock. The propagator station can then implements methods and techniques described in U.S. Pat. No. 10,225,993 entitled “Method for Automating Transfer of Plants within an Agricultural Factility” and incorporated herein by reference in its entirety, to scan the optical image for pest indicators, such as mold, insects (e.g., aphids), and/or indicators of rodent presence (e.g., rodent feces). For example, the propagator station can execute this process to check for pest presence in the rack upon initial receipt of a new rack from the seeding station, before the mover fully releases the rack in the rack dock, and before the propagator station draws the rack fully into the rack dock to engage the fill and/or drain ports in propagation trays in the rack to fill and/or drain connectors in this rack dock.

Accordingly, if the propagator station detects a pest or an indicator of pest presence in any propagation cartridge or propagation tray in this rack, the propagator station can reject the rack and flag it for immediate quarantine. The propagator station can also instruct or otherwise trigger the autonomous mover to deliver the rack to a quarantine station in the agricultural facility. For example, in some implementations the pest check can happen immediately or shortly after a rack is delivered to a rack dock and the pest check process can occur while the rack is still loaded onto the autonomous mover (or while the autonomous mover is still positioned underneath the rack).

However, if the propagator station fails to detect a pest or an indicator of pest presence in any propagation cartridge or propagation tray in this rack, the propagator station can confirm receipt of the rack and release the mover to execute other move actions within the agricultural facility (e.g., to load a next rack into the propagator station, to move other modules between grow locations and the transfer station in the agricultural facility). The propagator station can then trigger a latch component in the rack dock (e.g., latch component 680) to engage and retain the rack, engage fill connectors in the rack dock to corresponding fill ports on propagation trays in the rack, and engage drain connectors in the rack dock to corresponding drain ports on these propagation trays.

As an example, in some embodiments, each rack dock in the propagator station can include a latch actuator configured to extend a latch into the rack dock to define an initial stop for a rack when the rack is initially loaded into the rack dock by the mover and to maintain separation between the water supply and water return lines in the dock and fill and drain ports on propagation trays in the rack. Once the latch component is engaged to a latch element on the rack following the foregoing pest check, the propagation station can then retract the latch to draw the rack fully into the rack dock (e.g., by an additional one inch) and to engage the fill and drain ports on propagation trays in the rack to the fill and drain connectors in the rack dock, respectively.

Alternatively, each rack dock in the propagator station can include a spring element configured to define an initial stop for the rack when loaded into the rack dock by the mover and to maintain separation between the water supply and water return lines in the dock and fill and drain ports on propagation trays in the rack, and a latch (e.g., a mechanical or magnetic latch) configured to engage a corresponding latch element on the rack. The latch can draw the rack into the rack dock against the spring element, to retain the rack in the rack dock, and to engage the fill and drain ports on propagation trays in the rack to the fill and drain connectors in the rack dock, respectively.

6. Rack Identification and Propagation Schedule

Before, during, or after executing the pest check described above, the propagator station can also: capture a scan image of the rack; detect an optical fiducial on the rack in the scan image; interpret a rack identifier from the optical fiducial; retrieve a propagation schedule associated with the rack identifier or a seed type linked to the rack identifier; confirm the rack identifier is assigned to its current rack dock and/or that the seed type linked to the rack identifier is scheduled for seeding at the propagator station. If not, the propagator station can flag the mover to remove the rack from the propagator station. Otherwise, the propagator station can load the propagation schedule into a control scheduled for the rack dock currently occupied by this rack.

Additionally or alternatively, the propagator station can: capture a first scan image of a first propagation tray in the rack; detect an optical fiducial on the first propagation tray in the first scan image; interpret a propagation tray identifier from the optical fiducial; retrieve a propagation schedule associated with the propagation tray identifier or with a seed type linked to the propagation tray identifier; confirm the propagation tray identifier and/or that the seed type is scheduled for seeding at the propagator station; and repeat this process for each other propagation tray in the rack. Then, if any one propagation tray or seed type loaded into a propagation tray in the rack is not matched to a propagation tray or seed assignment for the rack dock or if the propagation schedules for these propagation trays are mismatched, the propagator station can flag the mover to remove the rack from the propagator station, such as for manual or automated correction at the seeding station. Otherwise, the propagator station can load a common propagation schedule for these propagation trays into a control scheduled for the corresponding propagation tray location in the rack dock.

7. Flood Cycle

The propagator station can then implement methods and techniques described above to illuminate and flood propagation trays in the rack according to their common or individual propagation schedules. Towards this end, in some embodiments each propagation tray location includes at least a first valve operatively coupled to a water supply line at the location and a second valve operatively coupled to a water drain line at the location. The first and second valves at each location can be individually and independently controlled by an actuator, for example a solenoid, in accordance with propagation schedules, to open or close thereby allowing water to flow into and/or out of propagation trays docked at each propagation tray location. Additionally, some embodiments include at least a third independent and individually controlled valve at each propagation tray location that is operatively coupled to a water drain overflow line at the location

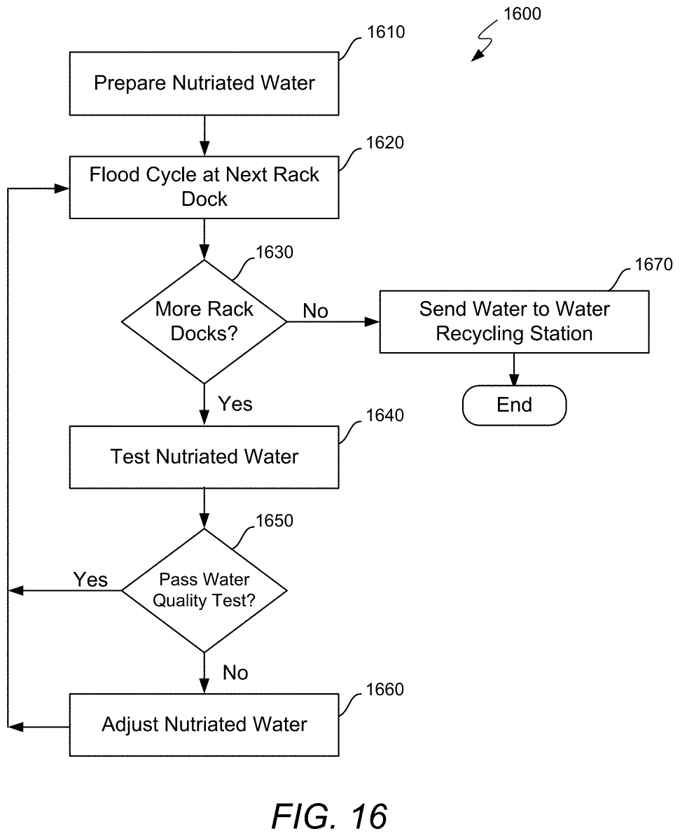

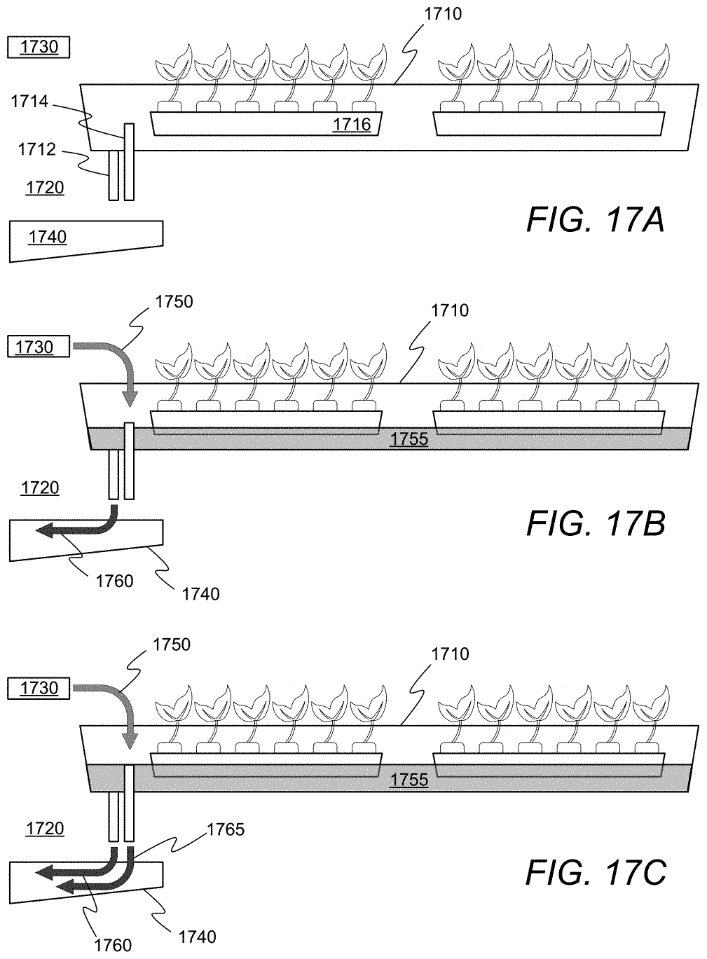

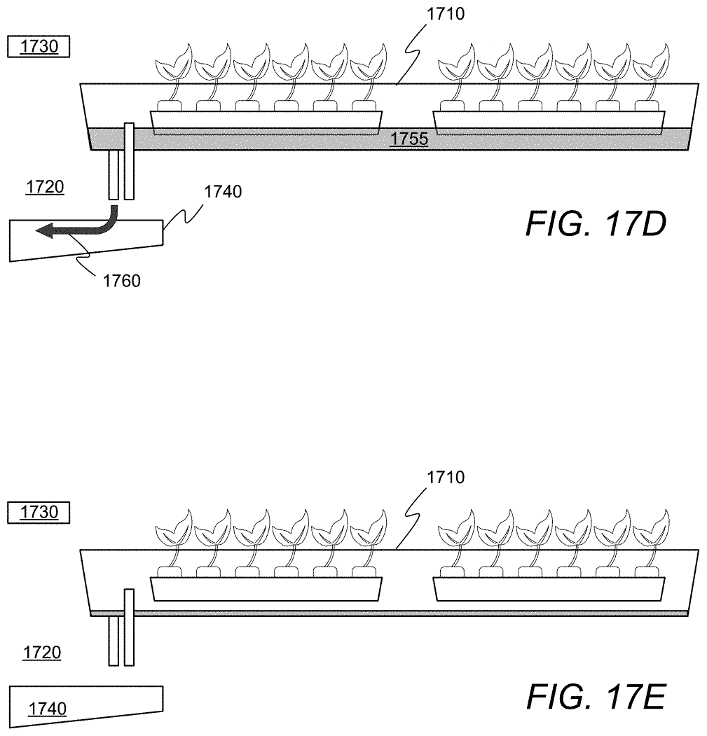

For example, after confirming absence of pests in the rack and locking a rack in the rack dock, the propagator station can open and close various ones of the first and second valves (and third valves when implemented) at each propagation tray location in the propagator station to initiate a flood cycle in propagation trays in the loaded rack. To illustrate, reference is made to FIGS. 16 and 17A-17E where FIG. 16 is a flowchart depicting steps associated with a method 1600 according to some embodiments of such a flood cycle and FIGS. 17A to 17E are simplified illustrations depicting the filling and draining of a propagation tray 1710 according to method 1600. As shown in each of FIGS. 17A-17E, a propagation tray 1710 is illustrated in a position in which the tray 1710 is docked with a rack dock at a propagation tray location 1720. Propagation tray 1710 includes a drain port 1712, an overflow drain port 1714 and several propagation cartridges 1716, each of which includes seeds or seedlings at various stages of growth. At each propagation tray location 1720 is a fill port 1730 and drain assembly 1740. Fill port 1730 is coupled to a water supply subsystem, including a nutriated water holding tank, and drain assembly 1740 is coupled to a water return subsystem.

a) Flood Cycle at First Rack Dock

Once the propagator station confirms a first rack has been loaded into a rack dock and that each propagation tray in the first rack occupying a first rack dock registers an absence of pests or pest, the propagator station can prepare nutriated water (FIG. 16, block 1610) in preparation for delivering the nutriated water to the first rack dock station. In some implementations the nutriated water can be prepared by filling holding tank 510 with freshwater (e.g., from a freshwater supply in the agricultural facility), metering nutrients (e.g., from nutrient supply tanks into the holding tank according to a nutrient level and pH specified in a propagation schedule assigned to the loaded rack, and activating an agitator to mix the nutrients into the fresh water in the holding tank. In some other implementations the nutriated water can be prepared by filling holding tank 510 with pre-nutriated water received from a nutrient mixing system within the agricultural facility. The propagator station 210 can then sample the set of water quality sensors to verify that qualities of the nutriated water in the holding tank fall within a tolerance of water qualities (e.g., pH, conductivity, turbidity, oxygen-reduction potential, chlorine residual, total organic carbon) specified in the propagation schedule assigned to the rack.

As an example, the propagator station can: fill the holding tank with a total quantity of water approximating (e.g., 110% of) the target nutriated water quantity designated for all propagation trays in a first rack loaded into a first rack dock in the propagator station (e.g., ˜132 gallons for a set of four propagation trays in the first rack, each propagation tray scheduled for loading with 30 gallons of nutriated water during a flood cycle); and implement closed-loop controls to adjust qualities of the nutriated water by selectively adding nutrients and/or water to the holding tank based on water quality data read from the set of water quality sensors and target water qualities specified in the propagation schedule.

Once the nutriated water has been prepared, a flood cycle can be initiated at the first rack dock (FIG. 16, block 1620). During the flood cycle, all drain valves in the loaded rack dock can be closed and all fill valves in the loaded rack dock can be opened. Additionally, all fill valves in the remaining rack docks in the propagator station can be closed while all drain valves in the remaining rack docks in the propagator station are opened.

The propagator station can then actuate a fill pump to pump nutriated water from the holding tank, through the water supply subsystem in the center wall, and into all propagation trays in the first rack as illustrated (with a single propagation tray 1710) in FIG. 17B. The nutriated water 1750 can flow into the propagation tray from a spigot 1730 that extends from the center wall over a fill port of the propagation tray as discussed above. Since drain valve 1712 is initially closed at this stage, a level of nutriated water 1755 within the basin of the propagation tray rises.

In the implementation of the propagation tray described above that excludes an overflow drain or a drain float valve, the propagator station can also actuate the fill pump for a preset period of time to dispense approximately the target volume of water from the holding tank into these propagation trays. Alternatively, the propagator station can actuate the fill pump, track volumes of nutriated water in each of these propagation trays based on outputs of a volume or mass flow rate sensor in the fluid supply line, and deactivate the fill pump once the target volume of nutriated water is metered into these propagation trays. Yet alternatively, the propagator station can actuate the fill pump, track volumes of nutriated water in each of these propagation trays based on outputs of fill level sensors (e.g., sonar or LIDAR sensors) located over each propagation tray by the center wall, and deactivate the fill pump once the target volume of nutriated water is metered into these propagation trays.

In the implementation of the propagation tray described above that includes an overflow drain or a drain float valve, the propagator station can continuously activate the fill pump during the flood cycle pouring nutriated water 1750 into the propagation tray throughout the flood cycle. Nutriated water 1755, within the basin of the propagation tray, in excess of the target or maximum fill levels of the propagation trays can thus drain back into the holding tank (represented by arrow 1760) via overflow drain 1714 as depicted in FIG. 17C. The fill pump can cycle the nutriated water (arrow 1760) back to the propagation trays during the flood cycle. Then, upon conclusion of the flood cycle (e.g., upon conclusion of a saturation duration specified in the propagation schedule), the propagator station can drain nutriated water from the propagation trays back into the holding tank (FIG. 17D), such as by: deactivating the fill pump; triggering drain valves in the rack dock to open; triggering drain ports 1712 in the propagation trays to open; and/or activating a drain pump to actively pump nutriated water out of the propagation trays and into the holding tank.

b) Flood Cycle at Second Rack Dock

Upon completing the flood cycle at a previous rack dock, the propagator station can check to see if there are additional rack docks with propagation trays to doss with nutriated water (FIG. 16, block 1630). If yes, propagator station can check the fill level, pH, nutrient level, and/or other characteristics of water in the holding tank via the set of water quality sensors in the holding tank (FIG. 16, block 1640) and compare the various test results to acceptable ranges set within the propagation schedule (FIG. 16, block 1650). Because grow media in propagation trays in the first rack may have absorbed both water and nutrients from the last flood cycle, one or more of the water test results may be outside of the accepted ranges (e.g., one or more nutrients levels in the water may be low or the pH level may have become to basic over time). In such situations, the water in the holding tank essentially fails the water quality test and it may be desirable to adjust the water characteristics in some manner prior to initiating a new flood cycle at a next rack dock.

In such instances, the propagator station can implement methods and techniques described above to regenerate the nutriated water. For example, the system can: add water from the freshwater supply to the holding tank to bring its water level up to a target holding tank water; dispense nutrients into the holding tank to bring the quality of nutriated water in the holding tank up to a target water quality specified in a second propagation schedule assigned to a second rack occupying a second rack dock in the propagator station, and/or add acid into the holding tank to adjust the pH level of the nutriated water to within a range specified in the second propagation schedule (FIG. 16, block 1660) prior to implementing the next flood cycle (FIG. 16, block 1620). If the water characteristics do not need to be adjusted based on the outcome of the test at block 1650 (i.e., water in the holding tank passes the water quality test), and there is a next rack dock to flood, method 1600 returns to block 1620 to implement a new flood cycle at the next propagation station.

Then, at a flood time specified in the next propagation schedule, the propagator station can implement methods and techniques described above to: verify absence of pests and/or pest indicators in propagation trays in the second rack; close all drain valves in the second rack dock; open all fill valves in the second rack dock; close all fill valves in the remaining rack docks; open all drain valves in the remaining rack docks; and flood the propagation trays in the second rack with nutriated water from the holding tank for a saturation duration specified in the second propagation schedule.

The propagator station can then repeat this process for each other rack currently occupying the propagator station.

c) Wastewater

Later (e.g., when there are no more rack docks to flood at that particular time, or when the nutriated water needs to be completely reconditioned), the propagator station can discard water from the holding tank (FIG. 16, block 1670), such as by returning this wastewater to the water recycling station within the agricultural facility. For example, the propagator station can release used nutriated water back to the water recycling station: after a threshold duration; after completing a maximum quantity of flood cycles at every rack dock on a side of the propagator station connected to the holding tank; or after an oxygen-reduction potential, a chlorine residual, or a total organic carbon of the nutriated water, read from sensors in the holding tank, falls outside of a target range specified in a propagation schedule for a rack currently occupying the propagator station.

The propagator station can then repeat the foregoing processes to prepare a new volume of nutriated water in the holding tank in preparation for a next flood cycle.

8. Propagation Records and Propagation Schedule Refinement

In one variation, the propagator station records time series ambient and water exposure data captured at each propagation tray location to seeding records for each propagation tray. The propagator station can also implement methods and techniques described in Ser. No. 15/955,651 to: capture tray-level images of plants in these propagation trays via optical sensors in each propagation tray location; extract plant quality metrics and plant outcomes from these tray-level images; write these plant quality metrics and seeding outcomes to corresponding seeding records for these propagation trays; implement artificial intelligence, machine learning, and/or regression techniques, etc. to derive relationships between plant qualities, seeding outcomes, and ambient and water exposure over a seeding period; and then automatically refine propagation schedules for subsequent batches of seedling based on these relationships.

9. Seedling Transfer

Later, upon completion of a propagation schedule assigned to a rack occupying a rack dock in the propagator station, the propagator station (and/or a computer system or other scheduler in the agricultural facility) can: trigger a lock in the rack dock to release the rack; and queue the mover to retrieve the rack from the rack dock and deliver the rack to a transfer station in the agricultural facility, such as described in U.S. application Ser. No. 17/384,560, filed on Jul. 23, 2021, entitled “System and Method for Automating Transfer of Plants within an Agricultural Facility”, and incorporated by reference herein in its entirety.

For example, upon receipt of a rack, a robotic raft manipulator (or a human operator) at the transfer station can: detect propagation trays in this rack; navigate an end effector into engagement with a propagation tray in the rack; unload this propagation tray from the rack; place this propagation tray onto a work table; detect propagation cartridges in this propagation tray; navigate the end effector into engagement with a first propagation cartridge in the propagation tray; unload this first propagation cartridge onto a first conveyor; repeat this process for each other propagation cartridge in this propagation tray; and repeat this process for each other propagation tray in the rack. During this process, the first conveyor can advance this sequence of propagation cartridges toward a robotic plant manipulator at the transfer station. A second conveyor can similarly advance a sequence of rafts, defining an array of plant slots and configured to float in a volume of water in a module, toward the robotic plant manipulator at the transfer station.

Accordingly, the robotic plant manipulator can: receive a first raft and a first propagation cartridge containing a grow media supporting a first set of plants; segment a first region of a grow media containing a first plant in the first set of plants; load the first region of the grow media into a first plant cup; and insert the first plant cup into a first plant slot in the first array of plant slots in the first raft.

In one implementation in which the robotic plant manipulator includes exchangeable end effectors, the robotic plant manipulator: receives a first propagation cartridge from the first conveyor; receives a first outbound raft from the second conveyor; loads a dicing end effector, such as include a rotary blade, a reciprocating blade, a laser-cutting head, a waterjet-cutting head; implements computer vision and/or artificial intelligence techniques to detect a first individual plant in the propagation cartridge; implements methods and techniques described above to characterize a first viability of the first plant; draws the dicing end effector around the base of the plant to cut a first region of grow media, containing the first plant, from the larger grow media mesh in the propagation cartridge; loads a gripper or other end effector configured to retain single plants and the grow media regions; engages the gripper end effector on the first grow media region; and lifts the first grow media region and the first plant out of the propagation cartridge.

Then, if the first viability of the first plant exceeds a threshold viability or falls within a target viability range, the robotic plant manipulator can: load the first grow media region and the first plant into a first plant cup located and retained by a plant cup dispenser arranged near the robotic plant manipulator; select a cup end effector configured to engage and manipulate a single plant cup; and then implement methods and techniques described above to detect and engage the first plant cup, now occupied by the first grow media region and the first plant, and load the first plant cup into a next-available plant slot in the first outbound raft.

Conversely, if the viability of the first plant falls below the threshold viability or falls outside of the target viability range, the robotic plant manipulator can discard the first grow media region and the first plant, such as by releasing the first grow media region and the first plant into a composting bin.

The robotic plant manipulator can then repeat this process in order to: fill all plant slots in the first outbound raft with plants from this propagation cartridge; empty the propagation cartridge into plant slots in additional outbound rafts; and similarly transfer plants from other inbound propagation cartridges into other outbound rafts. The second conveyor, the robotic raft manipulator, and the vehicle can then cooperate to load these outbound rafts into outbound modules and to deliver these loaded modules to grow locations throughout the agricultural facility.

In a similar implementation, the robotic plant manipulator can include a single end effector that defines multiple surfaces or actuators configured to dice the grow media, extract a region of grow media (e.g., from the propagation cartridge), load the region of grow media into a plant cup, and load the plant cup into a plant slot in a raft.

Alternatively, the system can include multiple robotic plant manipulators arranged within the transfer station, such as including: a first robotic plant manipulator configured to dice the grow media; a second robotic plant manipulator configured to extract a region of grow media (e.g., from the propagation cartridge) and to load the region of grow media into a plant cup; and a third robotic plant manipulator configured to load the plant cup into a plant slot in a raft.

### Additional Embodiments

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings including using the various aspects, embodiments, implementations or features of the described embodiments separately or in any appropriate combination.

As several examples, while the various embodiments described above implement propagation schedules one rack dock at a time, embodiments are not limited to such. Instead, some embodiments can implement flood cycles simultaneously at two or more rack docks or implement flood cycles within only a first subset of propagation tray locations at one rack dock, then implement flood cycles at one or more propagation locations of a second rack dock before implementing flood cycles at the remaining propagation tray locations in the first rack dock. Additionally, while propagation schedules were described above as being started after a rack is positioned at a rack dock and after a pest check, the pest check is optional and need not be performed in some embodiments.

Various aspects of the described embodiments can be implemented by software, hardware or a combination of hardware and software. The described embodiments can also be embodied as computer readable code on a computer readable medium for controlling operation of the disclosed speaker. For example, the systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

What is claimed is:

1. A propagation system for growing seeds to seedlings, the propagation system comprising:
a holding tank configured to be coupled to a water supply;
a first plurality of rack docks and a second plurality of rack docks;
a central wall disposed between and separating the first plurality of rack docks from the second plurality of rack docks, the central wall comprising water supply infrastructure configured to deliver nutriated water from the holding tank to the first and second plurality of rack docks and water return infrastructure configured to return nutriated water from the first and second plurality of rack docks to the holding tank;
one or more pumps operatively coupled to pump nutriated water through the water supply infrastructure and through the water return infrastructure;
wherein each rack dock in the first plurality of rack docks and each rack dock in the second plurality of rack docks defines a set of propagation tray locations, each propagation tray location in each set of propagation tray locations including at least one water supply line coupled to the water supply infrastructure and at least one water drain line coupled to the water return infrastructure.

2. The propagation system for growing seeds to seedlings set forth in claim 1 further comprising an acid dosing subsystem operatively coupled to add acid to water in the holding tank.

3. The propagation system for growing seeds to seedlings set forth in claim 1 wherein the holding tank is configured to be coupled to a fresh water supply and the propagation system further comprises:
one or more nutrient tanks operatively coupled to deliver nutrients to the holding tank; and
one or more nutrient pumps operatively coupled to meter nutrients from the one or more nutrient tanks into the holding tank.

4. The propagation system for growing seeds to seedlings set forth in claim 1 further comprising one or more sensors disposed within the holding tank to measure the pH and nutrient levels of water in the holding tank.

5. The propagation system for growing seeds to seedlings set forth in claim 4 further comprising a controller is operable to self-monitor growing conditions at a rack dock, in accordance with a propagation schedule assigned to the rack dock, by initiating a plurality of flood cycles to irrigate plants growing in propagation trays within the rack dock with nutriated water as the plants grow from a seek to seedling stage and adjusting nutrients in the nutriated water directed to the propagation trays in each flood cycle based on data received from the plurality of sensors.

6. The propagation system for growing seeds to seedlings set forth in claim 1 further comprising a plurality of water supply valves, a plurality of water drain valves, and a controller operatively coupled to open and close each of the water supply valves and each of the water drain valves in response to a propagation schedule.

7. The propagation system for growing seeds to seedlings set forth in claim 6 wherein each propagation tray location in each set of propagation tray locations includes: (i) at least one water supply valve operatively coupled to control a flow of nutriated water from the water supply infrastructure into the water supply line at the propagation tray location, and (ii) at least one water drain valve operatively coupled to control a flow of nutriated water from the propagation tray location into the water return infrastructure.

8. The propagation system for growing seeds to seedlings set forth in claim 7 wherein the controller is coupled to a computer-readable memory that stores the propagation schedule, and the controller is further operatively coupled to open and close each water supply valve and to open and close each water drain valve in accordance with the propagation schedule stored in the computer-readable memory.

9. The propagation system for growing seeds to seedlings set forth in claim 7 wherein the controller is operatively coupled to: (i) open and close each water supply valve at each propagation tray location independent from the water supply valves at every other propagation tray location, and (ii) open and close each water drain valve at each propagation tray location independent from the water drain valves at every other propagation tray location.

10. The propagation system for growing seeds to seedlings set forth in claim 1 wherein each rack dock includes a drain assembly positioned at each propagation tray location of the rack dock, the drain assembly including a bowl and a drain coupled to the water return infrastructure and configured to transport water received at the bowl to the water return infrastructure.

11. The propagation system for growing seeds to seedlings set forth in claim 1 further comprising a plurality of racks and a plurality of propagation trays, wherein each rack defines a set of levels and each propagation tray sized and shaped to fit within one of the levels on a rack.

12. The propagation system for growing seeds to seedlings set forth in claim 1 further comprising a plurality of propagation trays, each propagation tray comprising a basin configured to hold a plurality of plants in a bath of water and a drain port located in a sump region of the propagation tray.

13. The propagation system for growing seeds to seedlings set forth in claim 12 wherein each propagation tray further comprises a fill port separated from a portion of the basin by a barrier wall that extends between first and second opposing sides of the propagation tray.

14. The propagation system for growing seeds to seedlings set forth in claim 12 wherein each propagation tray further comprises a stopper pivotably coupled to a bottom surface of the propagation tray, the stopper comprising a sealing plate that can be rotated, at an axis defined by a hinge, between a closed position in which the sealing plate covers and seals the drain port and an open position in which the sealing plate is rotated away from the drain port.

15. The propagation system for growing seeds to seedlings set forth in claim 14 wherein the stopper further comprises a biasing mechanism that biases the sealing plate into the closed position and a gasket coupled to the sealing plate, wherein the gasket is positioned to contact and cover the drain port when the stopper is in the closed position.

16. The propagation system for growing seeds to seedlings set forth in claim 1 wherein each rack in the plurality of racks includes an armature plate and wherein each rack dock in the first and second pluralities of rack docks comprises further comprises an electromagnet aligned to mate with the armature plate of a rack in the plurality of racks to pull the rack into and secure the rack within the rack dock.

17. The propagation system for growing seeds to seedlings set forth in claim 1 wherein the system is a stand-alone system that can be moved to different locations within an agricultural facility without taking the system apart.

18. A method for growing a first plurality of plants from seeds to a seedling stage in a first propagator station tray positioned within a first docking area of propagator station and a second plurality of plants in a second propagation tray positioned within a second docking area of the propagator station, wherein the propagator station includes a holding tank, and one or more water quality sensors, and wherein the method comprises:
preparing an initial batch of nutriated water in the holding tank;
irrigating the first plurality of plants with the nutriated water by flowing the nutriated water into the first propagation tray in accordance with a first propagation schedule;
draining nutriated water from the first propagation tray and returning the drained water to the holding tank;
measuring one or more characteristics of the drained water with the one or more water quality sensors to determine if the water quality meets predetermined criteria established for the second propagation schedule;
if the water quality meets the predetermined criteria, irrigating the second plurality of plants with the drained water in accordance with the second propagation schedule; and
if the water quality does not meet the predetermined criteria, preparing adjusted nutrient water by adding one or more nutrients from the one or more nutrient tanks to the drained water and irrigating the second plurality of plants with the adjusted nutriated water by flowing the adjusted nutriated water into the second propagation tray according in accordance with the second propagation schedule.

19. The method set forth in claim 18 wherein the propagator station further comprises one or more nutrient tanks and the step of preparing an initial batch of nutriated water in the holding tank includes combining fresh water with nutrients from the one or more nutrient tanks.

20. The method set forth in claim 18 wherein:
the propagator station further comprises an acid dosing subsystem;
the step of measuring one or more characteristics of the drained water includes measuring a pH level of the drained water; and
the method further includes, if the pH level of the drained water is above a predetermined range established for the second propagation schedule, preparing adjusted nutrient water by adding acid to the drained water and irrigating the second plurality of plants with the adjusted nutriated water by flowing the adjusted nutriated water into the second propagation tray according in accordance with the second propagation schedule.

21. The method set forth in claim 18 wherein the propagator station includes a plurality of rack docks, the first propagation tray is one of a plurality of first propagation trays stacked vertically within a first rack dock and the second propagation tray is one of a plurality of second propagation trays stacked vertically within a second rack dock.

22. The method set forth in claim 21 wherein:
irrigating the first plurality of plants with the nutriated water flows the nutriated water into each of the first propagation trays in the plurality of first propagation trays in accordance with the first propagation schedule;
draining the nutriated water from the first propagation tray and returning the drained water to the holding tank drains the water from each of the first propagation trays in the plurality of first propagation trays;
irrigating the second plurality of plants with the drained water flows the drained water into each of the second propagation trays in the plurality of second propagation trays in accordance with the second propagation schedule; and
irrigating the second plurality of plants with the adjusted nutriated water flows the adjusted nutriated water into each of the second propagation tray in the plurality of second propagation trays in accordance with the second propagation schedule.
